(19) United States
(12) Patent Application Publication
(10) Pub. No.: US 2023/0191941 A1
(43) Pub. Date: Jun. 22, 2023

(54) POWER SUPPLY MANAGEMENT METHOD, POWER SUPPLY MANAGEMENT DEVICE, AND NON-TRANSITORY COMPUTER READABLE RECORDING MEDIUM STORING POWER SUPPLY MANAGEMENT PROGRAM

(71) Applicant: Panasonic Intellectual Property Corporation of America, Torrance, CA (US)

(72) Inventors: Eiichi NAITO, Kyoto (JP); Takahiro KUDOH, Kyoto (JP)

(73) Assignee: Panasonic Intellectual Property Corporation of America, Torrance, CA (US)

(21) Appl. No.: 18/112,637

(22) Filed: Feb. 22, 2023

Related U.S. Application Data
(63) Continuation of application No. PCT/JP2021/016769, filed on Apr. 27, 2021.

(30) Foreign Application Priority Data
Aug. 31, 2020 (JP) 2020-145513

(51) Int. Cl. B60L 55/00; H01M 10/42; H02J 13/00; B60L 53/66; G06Q 50/06

(52) U.S. Cl. CPC B60L 55/00; H01M 10/42; H02J 13/00004; B60L 53/66; G06Q 50/06

(57) ABSTRACT

A server receives, from a certain house having power outage among a plurality of houses, supply request information about a request for an electric power supply to the certain house, retrieves, with reference to a database associating the houses with a plurality of electric vehicles configured to supply electric power respectively to the houses, a candidate electric vehicle that enables the electric power supply to the certain house among the electric vehicles associated with other houses different from the certain house, transmits, to a terminal associated with the retrieved candidate electric vehicle, cooperation request information about a request for the electric power supply from the candidate electric vehicle to the certain house, and transmits, when receiving from the terminal reply information indicating acceptance of the electric power supply to the certain house, location information about a location of the certain house to the terminal.

### TECHNICAL FIELD

This disclosure relates to a technology of managing an electric power supply to a house by an electric vehicle.

### BACKGROUND ART

Use of electric power from an electric vehicle as a domestic electric power supply source has attracted attention from the viewpoints of wide spreading of such electric vehicles and preparation for power outage at a disaster.

For instance, Patent Literature 1 discloses a power source switching device for supplying electric power charged in a main battery unit of an electric vehicle to house loaders on an occurrence of power outage attributed to a commercial electric power system.

However, the conventional technology faces difficulty in satisfactorily supplying the electric power to the house loaders in the power outage when the electric vehicle is not connected to the house or the electric power charged to the electric vehicle is insufficient, and thus needs further improvement.

### CITATION LIST

### Patent Literature

Patent Literature 1: Japanese Patent Publication No. 5781012

### SUMMARY OF INVENTION

This disclosure has been achieved to solve the drawbacks described above, and has an object of providing a technology of supplying electric power to a house even in power outage.

An electric power supply management method according to one aspect of the disclosure includes, by a computer: receiving, from a certain house having power outage among a plurality of houses, first request information about a request for an electric power supply to the certain house; retrieving, with reference to a database associating the houses with a plurality of electric vehicles configured to supply electric power respectively to the houses, a candidate electric vehicle that enables the electric power supply to the certain house among the electric vehicles associated with other houses different from the certain house; transmitting, to a terminal associated with the retrieved candidate electric vehicle, second request information about a request for the electric power supply from the candidate electric vehicle to the certain house; and transmitting, when receiving from the terminal reply information indicating acceptance of the electric power supply to the certain house, location information about a location of the certain house to the terminal.

This disclosure achieves an electric power supply to a house even in power outage.

### BRIEF DESCRIPTION OF DRAWINGS

FIG. 1 shows an overall configuration of an information processing system in a first embodiment of the disclosure.

FIG. 2 shows a configuration of an electric power supply controller in the first embodiment of the disclosure.

FIG. 3 shows a configuration of a server in the first embodiment of the disclosure.

FIG. 4 shows a configuration of a terminal in the first embodiment of the disclosure.

FIG. 5 is a first flowchart explaining an operation by the electric power supply controller in the first embodiment of the disclosure.

FIG. 6 is a second flowchart explaining the operation by the electric power supply controller in the first embodiment of the disclosure.

FIG. 7 shows an example of a request confirmation screen image in the first embodiment.

FIG. 8 shows an example of a vehicle position confirmation screen image in the first embodiment.

FIG. 9 is a first flowchart explaining an operation by the server in the first embodiment of the disclosure.

FIG. 10 is a second flowchart explaining the operation by the server in the first embodiment of the disclosure.

FIG. 11 is a first flowchart explaining an operation by the terminal in the first embodiment of the disclosure.

FIG. 12 is a second flowchart explaining the operation by the terminal in the first embodiment of the disclosure.

FIG. 13 shows an example of an electric power supply cooperation request screen image in the first embodiment.

FIG. 14 shows an example of an electric power suppliable place display screen image in the first embodiment.

FIG. 15 shows an example of an incentive information display screen image in the first embodiment.

FIG. 16 shows an overall configuration of an information processing system in a modification of the first embodiment of the disclosure.

FIG. 17 shows a configuration of an electric power supply controller in the modification of the first embodiment of the disclosure.

FIG. 18 is a first flowchart explaining an operation by the electric power supply controller in the modification of the first embodiment of the disclosure.

FIG. 19 is a second flowchart explaining the operation by the electric power supply controller in the modification of the first embodiment of the disclosure.

FIG. 20 shows an example of a request confirmation screen image in the modification of the first embodiment.

FIG. 21 shows a configuration of an electric power supply controller in a second embodiment of the disclosure.

FIG. 22 shows a configuration of a server in the second embodiment of the disclosure.

FIG. 23 is a first flowchart explaining an operation by the electric power supply controller in the second embodiment of the disclosure.

FIG. 24 is a second flowchart explaining the operation by the electric power supply controller in the second embodiment of the disclosure.

FIG. 25 shows an example of a vehicle selection receipt screen image in the second embodiment.

FIG. 26 is a first flowchart explaining an operation by the server in the second embodiment of the disclosure.

FIG. 27 is a second flowchart explaining the operation by the server in the second embodiment of the disclosure.

### DESCRIPTION OF EMBODIMENTS

Knowledge forming the basis of the present disclosure

A power source switching device according to the conventional technology as described above supplies, to a house loader, electric power charged in a main battery unit of an electric vehicle on an occurrence of power outage attributed to a commercial electric power system. However, the device fails to supply the electric power to the house loader when the electric vehicle is not connected to the house on the occurrence of the power outage. Moreover, in a case where the electric power charged in the electric vehicle is insufficient, the device fails to satisfactorily supply the electric power to the house loader even when the electric vehicle is connected to the house.

To solve these drawbacks, an electric power management method according to one aspect of the disclosure includes, by a computer: receiving, from a certain house having power outage among a plurality of houses, first request information about a request for an electric power supply to the certain house; retrieving, with reference to a database associating the houses with a plurality of electric vehicles configured to supply electric power respectively to the houses, a candidate electric vehicle that enables the electric power supply to the certain house among the electric vehicles associated with other houses different from the certain house; transmitting, to a terminal associated with the retrieved candidate electric vehicle, second request information about a request for the electric power supply from the candidate electric vehicle to the certain house; and transmitting, when receiving from the terminal reply information indicating acceptance of the electric power supply to the certain house, location information about a location of the certain house to the terminal.

According to this configuration, a candidate electric vehicle that enables the electric power supply to the certain house is retrieved among the electric vehicles associated with other houses different from the certain house having the power outage. Besides, when a user of the retrieved candidate electric vehicle accepts the electric power supply to the certain house, location information about the location of the certain house is transmitted to the terminal associated with the candidate electric vehicle. Owing to the presentation of the location of the certain house on the terminal having received the location information, the user of the candidate electric vehicle allows the candidate electric vehicle to travel to the certain house. As a result, a storage battery included in the candidate electric vehicle is connected to the certain house to achieve the electric power supply from the candidate electric vehicle to the certain house.

It is seen from this perspective that an electric vehicle that enables an electric power supply travels to a house having power outage to supply the electric power from the electric vehicle to the house having the power outage, and therefore achieves the electric power supply to the house even in the power outage.

The electric power supply method may further include: receiving, in a case where a specific electric vehicle is in a state of supplying electric power to the certain house, from the certain house an electric power suppliable time indicating a time available for the specific electric vehicle in the state of supplying electric power to continue the supplying of electric power to the certain house. In the retrieval of the candidate electric vehicle, the candidate electric vehicle may be among electric vehicles each having a possibility of reaching the certain house within the electric power suppliable time.

According to this configuration, in the case where a specific vehicle is in the state of supplying electric power to the certain house having the power outage, the candidate electric vehicle that enables the electric power supply reaches the certain house before the battery remaining amount of the electric vehicle in the state of supplying the electric power runs out, and thus can take over the electric power supply to the certain house having the power outage without suspension.

In the electric power supply method, in the retrieval of the candidate electric vehicle, the candidate electric vehicle may be among electric vehicles each having a battery remaining amount which is larger than a power consumptive amount required for the electric vehicle traveling from a current position thereof to a chargeable place via the certain house.

According to this configuration, the candidate electric vehicle is retrieved among electric vehicles each having a battery remaining amount which is larger than a power consumptive amount required for the electric vehicle traveling from a current position thereof to a chargeable place via the certain house. This can prevent the candidate electric vehicle from stopping while traveling.

In the electric power supply method, in the retrieval of the candidate electric vehicle, the candidate electric vehicle may provide a largest residual amount in subtraction of the power consumptive amount from the battery remaining amount thereof.

This configuration permits the candidate electric vehicle providing the largest residual amount in subtraction of the power consumptive amount from the battery remaining amount thereof to travel to the certain house, and thus enables the electric power supply from the single candidate electric vehicle to the certain house for a long time.

In the electric power supply method, in the retrieval of the candidate electric vehicle, the candidate electric vehicle may have a shortest travel time from a current position thereof to the certain house among the electric vehicles or have a shortest travel distance from a current position thereof to the certain house among the electric vehicles.

This configuration permits the candidate electric vehicle having the possibility of reaching the certain house in a shorter time to travel to the certain house, and thus achieves a shorter time of the power outage of the certain house.

The electric power supply method may further include: receiving, from the certain house, power outage cease information indicating that the power outage has ceased; and transmitting, to the terminal, cancellation information about cancellation of the request for the electric power supply to the certain house, upon receiving the power outage cease information after transmitting the second request information.

This configuration succeeds in notifying the user of the candidate electric vehicle that the power outage has ceased in the case where the power outage has ceased after receipt of the request for the electric power supply to the certain house.

The electric power supply method may further include: calculating an incentive to be given to a user of the candidate electric vehicle for the electric power supply to the certain house by the candidate electric vehicle; and transmitting information about the calculated incentive to the terminal.

This configuration gives an incentive to the user of the candidate electric vehicle for the electric power supply to the certain house by the candidate electric vehicle, and thus contributes to an increase in the number of users who are willing to cooperate in the electric power supply.

In the electric power supply method, in the calculation of the incentive, the incentive may be calculated to increase in accordance with an increase in the amount of the electric power supply from the candidate electric vehicle to the certain house, in a traveling time of the candidate electric vehicle to the certain house, or in a power supplying time of the candidate electric vehicle to the certain house.

This configuration attains a further increase in the willingness of each user of the corresponding candidate electric vehicle to cooperate in the electric power supply.

The electric power supply method may further include transmitting the current position of the candidate electric vehicle when receiving, from the terminal, the reply information indicating the acceptance of the electric power supply to the certain house.

According to this configuration, the resident of the certain house can confirm the current position of the candidate electric vehicle traveling to the certain house, and thus can grasp a time required for ceasing of the power outage.

In the electric power supply method, in the retrieval of the candidate electric vehicle, one or more candidate electric vehicles may be retrieved. The electric power supply method may further include: transmitting, to the certain house, vehicle presentation information for presenting information about the retrieved one or more candidate electric vehicles before a resident of the certain house; receiving, from the certain house, selected vehicle information about a candidate electric vehicle selected from the retrieved one or more candidate electric vehicles by the resident; and transmitting, in the transmission of the second request information, the second request information to the terminal associated with the candidate electric vehicle indicated by the received selected vehicle information.

According to this configuration, the second request information is transmitted to the terminal associated with the candidate electric vehicle selected from the retrieved one or more candidate electric vehicles by the resident. Therefore, this configuration permits the candidate electric vehicle desired by the resident of the certain house to travel to the certain house.

The electric power supply method may further include, when receiving reply information indicating unacceptance of the electric power supply to the certain house from the terminal, retrieving, with reference to the database, another candidate electric vehicle that enables the electric power supply to the certain house among electric vehicles associated with the houses except for the electric vehicle showing the unacceptance.

This configuration enables retrieval of another candidate electric vehicle when the retrieved candidate electric vehicle cannot travel to the certain house.

An electric power supply management device according to another aspect of the disclosure includes: a first request information receiving section that receives, from a certain house having power outage among a plurality of houses, first request information about a request for an electric power supply to the certain house; a retrieving section that retrieves, with reference to a database associating the houses with a plurality of electric vehicles configured to supply electric power respectively to the houses, a candidate electric vehicle that enables the electric power supply to the certain house among electric vehicles associated with other houses different from the certain house; a second request information transmitting section that transmits, to a terminal associated with the retrieved candidate electric vehicle, second request information about a request for the electric power supply from the candidate electric vehicle to the certain house; and a location information transmitting section that transmits, when receiving from the terminal reply information indicating acceptance of the electric power supply to the certain house, location information about a location of the certain house to the terminal.

According to this configuration, a candidate electric vehicle that enables the electric power supply to the certain house is retrieved among the electric vehicles associated with other houses different from the certain house having the power outage. Besides, when a user of the retrieved candidate electric vehicle accepts the electric power supply to the certain house, location information about the location of the certain house is transmitted to the terminal associated with the candidate electric vehicle. Owing to the presentation of the location of the certain house on the terminal having received the location information, the user of the candidate electric vehicle allows the candidate electric vehicle to travel to the certain house. As a result, a storage battery included in the candidate electric vehicle is connected to the certain house to achieve the electric power supply from the candidate electric vehicle to the certain house.

It is seen from this perspective that an electric vehicle that enables an electric power supply travels to a house having power outage to supply the electric power from the electric vehicle to the house having the power outage, and therefore achieves the electric power supply to the house even in the power outage.

A non-transitory computer readable recording medium storing an electric power supply management program according to further another aspect of the disclosure causes a computer to serve as: receiving, from a certain house having power outage among a plurality of houses, first request information about a request for an electric power supply to the certain house; retrieving, with reference to a database associating the houses with a plurality of electric vehicles configured to supply electric power respectively to the houses, a candidate electric vehicle that enables the electric power supply to the certain house among the electric vehicles associated with other houses different from the certain house; transmitting, to a terminal associated with the retrieved candidate electric vehicle, second request information about a request for the electric power supply from the candidate electric vehicle to the certain house; and transmitting, when receiving from the terminal reply information indicating acceptance of the electric power supply to the certain house, location information about a location of the certain house to the terminal.

According to this configuration, a candidate electric vehicle that enables the electric power supply to the certain house is retrieved among the electric vehicles associated with other houses different from the certain house having the power outage. Besides, when a user of the retrieved candidate electric vehicle accepts the electric power supply to the certain house, location information about the location of the certain house is transmitted to the terminal associated with the candidate electric vehicle. Owing to the presentation of the location of the certain house on the terminal having received the location information, the user of the candidate electric vehicle allows the candidate electric vehicle to travel to the certain house. As a result, a storage battery included in the candidate electric vehicle is connected to the certain house to achieve the electric power supply from the candidate electric vehicle to the certain house.

It is seen from this perspective that an electric vehicle that enables an electric power supply travels to a house having power outage to supply the electric power from the electric vehicle to the house having the power outage, and therefore achieves the electric power supply to the house even in the power outage.

Hereinafter, embodiments of the disclosure will be described with reference to the accompanying drawings. It should be noted that each of the following embodiments illustrates one example of the disclosure, and does not delimit the technical scope of the disclosure.

### First Embodiment

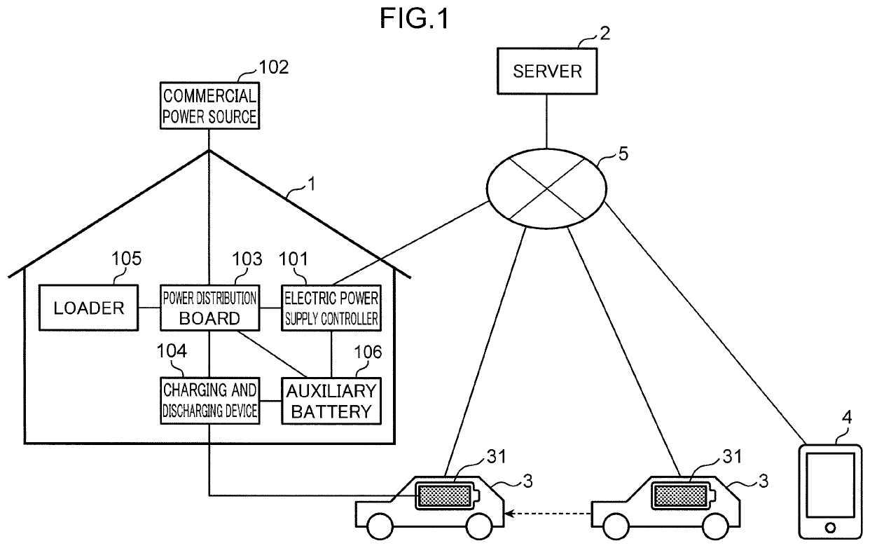

FIG. 1 shows an overall configuration of an information processing system in a first embodiment of the disclosure.

The information processing system shown in FIG. 1 includes an electric power supply controller 101, a server 2, an electric vehicle 3, and a terminal 4.

The electric power supply controller 101 is disposed in a house 1. A power distribution board 103, a charging and discharging device 104, a loader 105, and an auxiliary battery 106 are disposed in the house 1, in addition to the electric power supply controller 101.

The power distribution board 103 is connected to a commercial power supply source 102, the charging and discharging device 104, and the loader 105. The commercial power supply source 102 is run by an electricity company to supply electric power to each house.

The loader 105 represents an appliance consuming electric power. Examples of the loader 105 include a house appliance, such as a television, a refrigerator, a washing machine, a rice cooker, an electric water heater, and an air conditioner.

The charging and discharging device 104 is connected to an electric vehicle 3 when the house 1 has power outage. The charging and discharging device 104 discharges a storage battery 31 mounted on the electric vehicle 3 to supply the electric power from the storage battery 31 to the power distribution board 103 in the power outage of the house 1.

The power distribution board 103 is configured to switch an electric power system between the commercial power supply source 102 and the charging and discharging device 104. The power distribution board 103 is configured to supply electric power from the commercial power supply source 102 to the loader 105 and supply electric power from the charging and discharging device 104 to the loader 105. Normally, the power distribution board 103 supplies the electric power from the commercial power supply source 102 to the loader 105.

In the first embodiment, no electric vehicle is parked at the house 1 and connected to the charging and discharging device 104 on the occurrence of the power outage of the house 1.

The power distribution board 103 outputs power outage information to the electric power supply controller 101 when the electric power supply from the commercial power supply source 102 is suspended, i.e., when the house 1 has power outage. The power distribution board 103 outputs power outage cease information to the electric power supply controller 101 when the electric power supply from the commercial power supply source 102 is resorted, i.e., when the power outage of the house 1 ceases.

The auxiliary battery 106 stores electric power required for the electric power supply controller 101, the power distribution board 103, and the charging and discharging device 104 to operate in power outage. The auxiliary battery 106 supplies the electric power to the electric power supply controller 101, the power distribution board 103, and the charging and discharging device 104 in the power outage.

The electric power supply controller 101 is communicably connected to the server 2 via a network 5 therebetween. The network 5 includes, for example, the internet.

The electric vehicle 3 is owned by a user living in other house different from the house 1. The electric vehicle 3 includes the storage battery 31 mounted thereon and travels by supplying electric power charged in the storage battery 31 to an electric motor. The storage battery 31 includes, for example, a lithium-ion battery to store the electric power by charging and supply the electric power to the electric motor by discharging. The electric vehicle 3 further supplies the electric power stored in the storage battery 31 to the house.

The electric vehicle 3 is communicably connected to the server 2 via the network 5 therebetween. The electric vehicle 3 includes a GPS (Global Positioning System) receiver for acquiring position information about a current position of the electric vehicle 3. The electric vehicle 3 periodically transmits acquired position information to the server 2. The electric vehicle 3 further periodically transmits, to the server 2, a battery remaining amount of the storage battery 31 mounted on the electric vehicle 3.

The terminal 4 is owned by the user who owns the electric vehicle 3. The terminal 4 includes, for example, a smartphone or a tablet computer. The terminal 4 is communicably connected to the server 2 via the network 5 therebetween.

The server 2 includes, for example, a Web server. The server 2 is an example of the electric power management device.

Hereinafter, a schematic operation by the information processing system in the first embodiment will be described.

When the house 1 has power outage, the electric power supply controller 101 disposed in the house 1 transmits, to the server 2, supply request information about a request for an electric power supply to the house 1 having the outage. The server 2 retrieves, when receiving the supply request information, a candidate electric vehicle that enables the electric power supply to the house 1 among the electric vehicles associated with other houses different from the house 1 having the power outage. The candidate electric vehicle retrieved here corresponds to the electric vehicle 3. The server 2 then transmits, to the terminal 4 associated with the retrieved electric vehicle 3, cooperation request information about a request for the electric power supply from the electric vehicle 3 to the house 1. The terminal 4 transmits, to the server 2, cooperation reply information indicating acceptance or unacceptance of the electric power supply to the house 1 when receiving the cooperation request information. Here, the cooperation reply information indicating the acceptance is transmitted to the server 2.

The server 2 transmits house location information about a location of the house 1 to the terminal 4 when receiving the cooperation reply information indicating the acceptance. The terminal 4 having received the house location information presents the received house location information before the user of the electric vehicle 3. The electric vehicle 3 is driven by the user to travel to the house 1. When the electric vehicle 3 reaches the house 1, the electric vehicle 3 is connected to the house 1 to supply the electric power from the electric vehicle 3 to the house 1. In this manner, the loader 105 is available even in the house 1 having the power outage owing to the electric power supply by the electric vehicle 3.

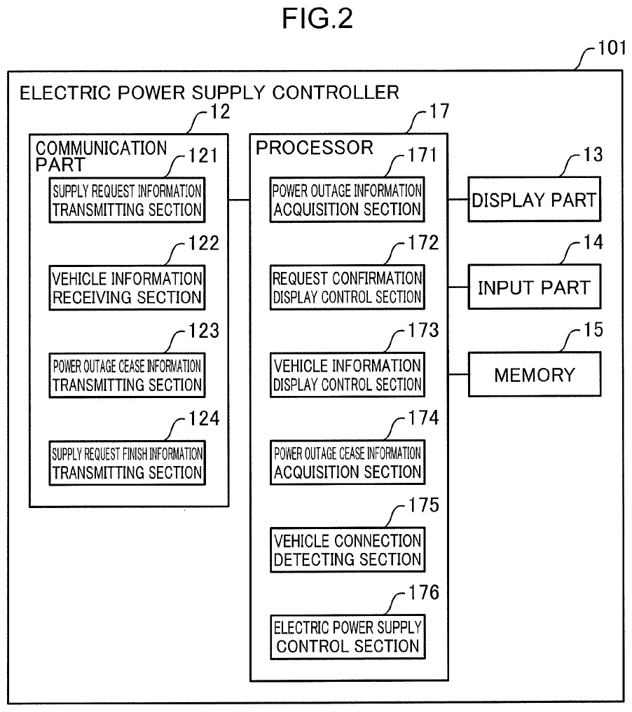

FIG. 2 shows a configuration of the electric power supply controller in the first embodiment of the disclosure.

The electric power supply controller 101 shown in FIG. 2 includes a communication part 12, a display part 13, an input part 14, a memory 15, and a processor 17.

The display part 13 includes, for example, a liquid crystal display, and displays various kinds of information.

The input part 14 includes, for example, a touch screen to receive an input by the user.

For instance, the memory 15 includes a storage device, such as a RAM (Random Access Memory) and an SSD (Solid State Drive), or flash memory, for storing various kinds of information. The memory 15 stores various kinds of information.

The communication part 12 includes a supply request information transmitting section 121, a vehicle information receiving section 122, a power outage cease information transmitting section 123, and a supply request finish information transmitting section 124.

The processor 17 includes, for example, a central processing unit (CPU). The processor 17 includes a power outage information acquisition section 171, a request confirmation display control section 172, a vehicle information display control section 173, a power outage cease information acquisition section 174, a vehicle connection detecting section 175, and an electric power supply control section 176.

The power outage information acquisition section 171 acquires, from the power distribution board 103, power outage information indicating suspension of the electric power supply from the commercial power supply source 102, i.e., indicating power outage of the house 1.

When the power outage information acquisition section 171 acquires the power outage information, the request confirmation display control section 172 causes the display part 13 to display a request confirmation screen image for allowing a user to confirm whether to make a request for an electric power supply to the house 1 having the power outage. The input part 14 receives, on the request confirmation screen image, an input by the user as to whether to make the request for the electric power supply to the house 1 having the power outage.

The supply request information transmitting section 121 transmits, to the server 2, supply request information (first request information) about the request for the electric power supply to the house 1 having the power outage. When the input part 14 receives the request for the electric power supply to the house 1 having the power outage, the supply request information transmitting section 121 transmits the supply request information to the server 2.

The vehicle information receiving section 122 receives, from the server 2, vehicle information about the electric vehicle 3 owned by a user showing acceptance of the electric power supply to the house 1 having the power outage. The vehicle information includes, for example, a current position of the electric vehicle 3. The vehicle information may include a vehicle type of the electric vehicle 3.

The vehicle information display control section 173 causes the display part 13 to display, based on the vehicle information received by the vehicle information receiving section 122, a vehicle position confirmation screen image showing the current position of the electric vehicle 3 traveling to the house 1.

The power outage cease information acquisition section 174 acquires, from the power distribution board 103, power outage cease information indicating that the electric power supply from the commercial power supply source 102 is restored, i.e., indicating that the power outage of the house 1 has ceased.

When the power outage cease information acquisition section 174 acquires the power outage cease information, the power outage cease information transmitting section 123 transmits, to the server 2, the power outage cease information indicating that the power outage of the house 1 has ceased.

The vehicle connection detecting section 175 detects connection of the electric vehicle 3 to the charging and discharging device 104, and further detects disconnection of the electric vehicle 3 from the charging and discharging device 104. The charging and discharging device 104 in the connection to the electric vehicle 3 outputs a connection signal to the electric power supply controller 101 via the power distribution board 103. The vehicle connection detecting section 175 detects the connection of the electric vehicle 3 to the charging and discharging device 104 when receiving the connection signal from the charging and discharging device 104. The charging and discharging device 104 in the disconnection from the electric vehicle 3 outputs a disconnection signal to the electric power supply controller 101 via the power distribution board 103. The vehicle connection detecting section 175 detects the disconnection of the electric vehicle 3 from the charging and discharging device 104 when receiving the disconnection signal from the charging and discharging device 104.

When the vehicle connection detecting section 175 detects, in the power outage, the connection of the electric vehicle 3 to the charging and discharging device 104, the electric power supply control section 176 outputs, to the electric vehicle 3, an electric power supply instruction to start the electric power supply by the electric vehicle 3. When the power outage cease information acquisition section 174 acquires, in the power outage, the power outage cease information in the supplying of the electric power by the electric vehicle 3, the electric power supply control section 176 outputs, to the electric vehicle 3, an electric power supply finish instruction to finish the electric power supply by the electric vehicle 3.

The supply request finish information transmitting section 124 transmits, in the power outage, supply request finish information to the server 2 when the power outage cease information acquisition section 174 acquires the power outage cease information in the supplying of the electric power by the electric vehicle 3. Besides, the supply request finish information transmitting section 124 transmits, in the power outage, supply request finish information to the server 2 when the vehicle connection detecting section 175 detects disconnection of the electric vehicle 3 from the charging and discharging device 104 in the supplying of the electric power by the electric vehicle 3.

Moreover, a resident of the house 1 may go out in the supplying of the electric power from the electric vehicle 3. Hence, the display part 13 may display a finish confirmation screen image for confirming whether to finish the electric power supply by the electric vehicle 3. The supply request finish information transmitting section 124 may transmit the supply request finish information to the server 2 when the resident of the house 1 accepts the finish of the electric power supply on the finish confirmation screen image.

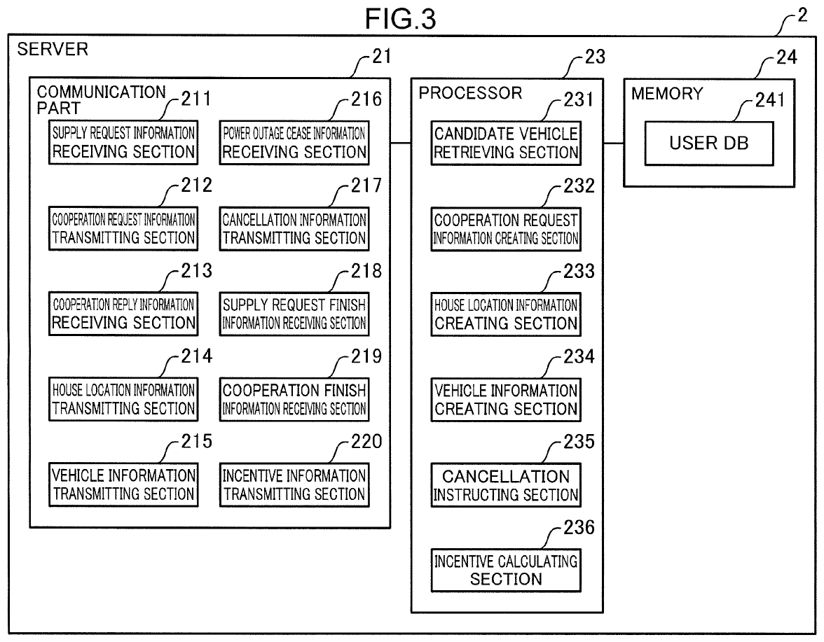

FIG. 3 shows a configuration of the server in the first embodiment of the disclosure.

The server 2 shown in FIG. 3 includes a communication part 21, a memory 24, and a processor 23.

The communication part 21 includes a supply request information receiving section 211, a cooperation request information transmitting section 212, a cooperation reply information receiving section 213, a house location information transmitting section 214, a vehicle information transmitting section 215, a power outage cease information receiving section 216, a cancellation information transmitting section 217, a supply request finish information receiving section 218, a cooperation finish information receiving section 219, and an incentive information transmitting section 220.

For instance, the memory 24 includes a storage device, such as a RAM, an HDD (Hard Disk Drive), and an SSD, or a flash memory, for storing various kinds of information. The memory 24 includes a user database (DB) 241.

The processor 23 includes, for example, a CPU. The processor 23 includes a candidate vehicle retrieving section 231, a cooperation request information creating section 232, a house location information creating section 233, a vehicle information creating section 234, a cancellation instructing section 235, and an incentive calculating section 236.

The user DB 241 stores a plurality of houses and a plurality of electric vehicles each enables an electric power supply to each of the houses in association with each other. More specifically, the user DB 241 stores; a house ID identifying a house; a vehicle ID identifying an electric vehicle that enables an electric power supply to the house; a terminal ID identifying a terminal owned by a user who owns the vehicle; a current position of the electric vehicle; a battery remaining amount of the electric vehicle; and a location of the house, in association with one another. The electric vehicle further periodically transmits, to the server 2, a current position of the electric vehicle and a battery remaining amount of the electric vehicle. The communication part 21 receives the current position and the battery remaining amount transmitted by the electric vehicle, and stores the received current position and battery remaining amount in the user DB 241. The user DB 241 may store only the latest position and the latest battery remaining amount of the electric vehicle, or may store a history of positions and battery remaining amounts of the electric vehicle.

The supply request information receiving section 211 receives, from the house 1 having the power outage among the plurality of houses, supply request information (first request information) about a request for an electric power supply to the house 1. The supply request information receiving section 211 receives the supply request information transmitted by the electric power supply controller 101.

The candidate vehicle retrieving section 231 retrieves, with reference to the user DB 241 associating the houses with a plurality of electric vehicles configured to supply electric power respectively to the houses, a candidate electric vehicle that enables the electric power supply to the house 1 among the electric vehicles associated with other houses different from the house 1 having the power outage.

The candidate vehicle retrieving section 231 retrieves the candidate electric vehicle among electric vehicles each having a battery remaining amount which is larger than a travel power consumptive amount required for the electric vehicle traveling from a current position thereof to a chargeable place via the house 1. Alternatively, the candidate vehicle retrieving section 231 retrieves a candidate electric vehicle providing a largest residual amount in subtraction of a travel power consumptive amount from a battery remaining amount thereof. The chargeable place may be the house of the user of the electric vehicle, or a place where a charger is provided around the house 1.

The candidate vehicle retrieving section 231 may retrieve a candidate electric vehicle having a shortest travel time from a current position thereof to the house 1 among the electric vehicles or having a shortest travel distance from a current position thereof to the house 1 among the electric vehicles. The candidate vehicle retrieving section 231 may retrieve a candidate electric vehicle having a shortest travel time from a current position thereof to the house 1 or having a shortest travel distance from the current position thereof to the house 1 among electric vehicles each having a battery remaining amount which is larger than a travel power consumptive amount required for the electric vehicle traveling from the current position thereof to a chargeable place via the house 1.

The candidate vehicle retrieving section 231 may retrieve a candidate electric vehicle having a shortest travel time from a current position thereof to the house 1 or having a shortest travel distance from the current position thereof to the house 1 among electric vehicles each having a residual amount in subtraction of a travel power consumptive amount from a battery remaining amount thereof, the residual amount being larger than a predetermined amount.

The candidate vehicle retrieving section 231 may retrieve a candidate electric vehicle providing a largest residual amount in subtraction of a travel power consumptive amount from a battery remaining amount thereof among electric vehicles each having a shorter travel time than a predetermined time from a current position thereof to the house 1. The candidate vehicle retrieving section 231 may retrieve a candidate electric vehicle providing a largest residual amount in subtraction of a travel power consumptive amount from a battery remaining amount thereof among electric vehicles each having a shorter travel distance from a current position of the electric vehicle to the house 1 than a predetermined distance.

The cooperation request information creating section 232 creates cooperation request information (second request information) about a request for the electric power supply from the candidate electric vehicle to the house 1.

The cooperation request information transmitting section 212 transmits the cooperation request information (second request information) created by the cooperation request information creating section 232 to a terminal associated with the candidate electric vehicle retrieved by the candidate vehicle retrieving section 231.

The cooperation reply information receiving section 213 receives, from the terminal 4, cooperation reply information (reply information) indicating acceptance or unacceptance of the electric power supply to the house 1.

The house location information creating section 233 creates house location information (location information) about a location of the house 1 when receiving, from the terminal 4, the cooperation reply information (reply information) indicating the acceptance of the electric power supply to the house 1.

The house location information transmitting section 214 transmits, to the terminal 4, the house location information (location information) about the location of the house 1 as created by the house location information creating section 233.

The vehicle information creating section 234 creates vehicle information including the current position of the candidate electric vehicle when receiving, from the terminal 4, the cooperation reply information indicating the acceptance of the electric power supply to the house 1.

The vehicle information transmitting section 215 transmits, to the house 1, the vehicle information created by the vehicle information creating section 234. The vehicle information transmitting section 215 transmits the vehicle information to the electric power supply controller 101 in the house 1.

When receiving reply information indicating unacceptance of the electric power supply to the house 1 from the terminal 4, the candidate vehicle retrieving section 231 retrieves, with reference to the user DB 241, another candidate electric vehicle that enables the electric power supply to the house 1 among electric vehicles associated with the houses except for the electric vehicle showing the unacceptance.

The power outage cease information receiving section 216 receives, from the house 1, power outage cease information indicating that the power outage of the house 1 has ceased. The power outage cease information receiving section 216 receives the power outage cease information from the electric power supply controller 101 in the house 1.

The cancellation instructing section 235 determines whether the power outage cease information is received after the cooperation request information (second request information) is transmitted. In a case where the power outage cease information is received after the cooperation request information (second request information) is transmitted, the cancellation instructing section 235 instructs the cancellation information transmitting section 217 to transmit cancellation information about cancellation of the request for the electric power supply to the house 1.

In the case where the power outage cease information is received after the cooperation request information (second request information) is transmitted, the cancellation information transmitting section 217 transmits, to the terminal 4, the cancellation information about the cancellation of the request for the electric power supply to the house 1.

The supply request finish information receiving section 218 receives, from the electric power supply controller 101, supply request finish information about finish of the electric power supply from the electric vehicle 3 to the house 1.

The cooperation finish information receiving section 219 receives, from the terminal 4, cooperation finish information about the finish of the electric power supply from the electric vehicle 3 to the house 1.

The incentive calculating section 236 calculates an incentive to be given to the user of the candidate electric vehicle for the electric power supply to the house 1 by the candidate electric vehicle. When the supply request finish information receiving section 218 receives the supply request finish information and the cooperation finish information receiving section 219 receives the cooperation finish information, the incentive calculating section 236 calculates the incentive to be given to the user of the candidate electric vehicle. For instance, the incentive includes a predetermined number of points to be given to the user of the electric vehicle 3 for the electric power supply to the house 1. For example, in online shopping, a fee amount corresponding to the number of points is discounted from a total payment fee.

The incentive calculating section 236 may calculate the incentive to increase in accordance with an increase in the amount of the electric power supply from the candidate electric vehicle to the house 1, in a travel time of the candidate electric vehicle to the house 1, or in a power supplying time of the candidate electric vehicle to the house 1.

For instance, the incentive includes remuneration to be paid to the user of the electric vehicle 3 for the electric power supply to the house 1 thereby. In this case, the incentive calculating section 236 may calculate, based on an amount of the electric power supply from the candidate electric vehicle to the house 1 and an electricity price, the remuneration to be paid to the user of the electric vehicle 3. The electricity price may be set by the user of the electric vehicle 3.

The incentive information transmitting section 220 transmits, to the terminal 4, incentive information about the incentive calculated by the incentive calculating section 236.

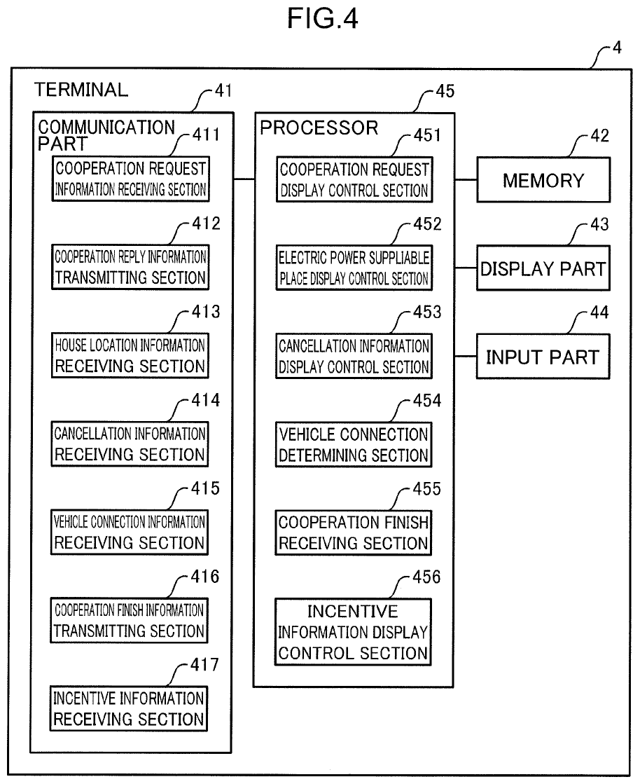

FIG. 4 shows a configuration of the terminal in the first embodiment of the disclosure.

The terminal 4 shown in FIG. 4 includes a communication part 41, a memory 42, a display part 43, an input part 44, and a processor 45.

For instance, the memory 42 includes a storage device, such as a RAM, an SSD, or a flash memory, for storing various kinds of information. The memory 42 stores various kinds of information.

The display part 43 includes, for example, a liquid crystal display, and displays various kinds of information.

The input part 44 includes, for example, a touch screen to receive an input by a user.

The communication part 41 includes a cooperation request information receiving section 411, a cooperation reply information transmitting section 412, a house location information receiving section 413, a cancellation information receiving section 414, a vehicle connection information receiving section 415, a cooperation finish information transmitting section 416, and an incentive information receiving section 417.

The processor 45 includes, for example, a CPU. The processor 45 includes a cooperation request display control section 451, an electric power suppliable place display control section 452, a cancellation information display control section 453, a vehicle connection determining section 454, a cooperation finish receiving section 455, and an incentive information display control section 456.

The cooperation request information receiving section 411 receives cooperation request information transmitted by the server 2.

The cooperation request display control section 451 causes the display part 43 to display, based on the cooperation request information received by the cooperation request information receiving section 411, an electric power supply cooperation request screen image for receiving acceptance or unacceptance of the cooperation request for the electric power supply to the house 1 having the power outage. The cooperation request information includes a distance from the house 1 having the power outage to the electric vehicle 3. The input part 44 receives, on the electric power supply cooperation request screen image, an input by the user as to whether to accept the cooperation request for the electric power supply to the house 1 having the power outage.

The cooperation reply information transmitting section 412 transmits, to the server 2, cooperation reply information indicating acceptance or unacceptance of the electric power supply to the house 1.

The house location information receiving section 413 receives the house location information transmitted by the server 2. The house location information includes the location of the house 1 and the name of the resident of the house 1. The electric power suppliable place display control section 452 causes the display part 43 to display an electric power suppliable place display screen image showing the location of the house 1 having the power outage and the name of the resident of the house 1. The user of the electric vehicle 3 confirms the location of the house 1 and the name of the resident of the house 1 as displayed on the electric power suppliable place display screen image, and drives the electric vehicle 3 to travel to the house 1.

The cancellation information receiving section 414 receives cancellation information transmitted by the server 2.

In a case where the cancellation information receiving section 414 receives the cancellation information after the cooperation request information is received, the cancellation information display control section 453 causes the display part 43 to display a cancellation screen image showing the cancellation of the request for the electric power supply to the house 1. For instance, in a case where the power outage of the house 1 has ceased before the electric vehicle 3 travels to the house 1, it is unnecessary for the electric vehicle 3 to travel to the house 1. Therefore, the user can know the unnecessity of traveling to the house 1 by confirming the cancellation screen image displayed on the display part 43. Further, for example, in a case where the power outage of the house 1 has ceased in the supplying of the electric power to the house 1 by the electric vehicle 3, the electric vehicle 3 can finish the electric power supply to the house 1. Hence, the user can know the unnecessity of the electric power supply to the house 1 by confirming the cancellation screen image displayed on the display part 43.

The vehicle connection information receiving section 415 receives, from the electric vehicle 3, vehicle connection information indicating connection of the electric vehicle 3 to the charging and discharging device 104. The electric vehicle 3 transmits the vehicle connection information to the terminal 4 when the electric vehicle 3 is connected to the charging and discharging device 104.

The vehicle connection determining section 454 determines whether the electric vehicle 3 is connected to the charging and discharging device 104. When the vehicle connection information receiving section 415 receives the vehicle information, the vehicle connection determining section 454 determines that the electric vehicle 3 is connected to the charging and discharging device 104.

The cooperation finish receiving section 455 receives selection by the user as to whether to finish the electric power supply from the electric vehicle 3 to the house 1. The cooperation finish receiving section 455 causes the display part 43 to display a selection receipt screen image for receiving selection by the user as to whether to finish the electric power supply from the electric vehicle 3 to the house 1. The user inputs, on the displayed selection receipt screen image, selection as to whether to finish the electric power supply from the electric vehicle 3 to the house 1.

For instance, in a case where the user has to go home in the supplying of the electric power from the electric vehicle 3 to the house 1, the user selects, on the displayed selection receipt screen image, finish of the electric power supply from the electric vehicle 3 to the house 1. Further, for example, in a case where the battery remaining amount of the electric vehicle 3 reaches a power consumptive amount required to travel from the house 1 to a chargeable place, the user selects, on the displayed selection receipt screen image, finish of the electric power supply from the electric vehicle 3 to the house 1.

The cooperation finish information transmitting section 416 transmits, to the server 2, cooperation finish information about the finish of the electric power supply from the electric vehicle 3 to the house 1. The cooperation finish information transmitting section 416 transmits the cooperation finish information to the server 2 when the cooperation finish receiving section 455 receives the selection by the user to finish the electric power supply from the electric vehicle 3 to the house 1.

The incentive information receiving section 417 receives incentive information transmitted by the server 2.

The incentive information display control section 456 causes the display part 43 to display an incentive information display screen image showing the incentive information received by the incentive information receiving section 417.

Although the information processing system includes the terminal 4 and the electric vehicle 3 independently of each other in the first embodiment, this disclosure is not particularly limited thereto, and the electric vehicle 3 may include the operability of the terminal 4.

Next, an operation by the electric power supply controller 101 in the first embodiment of the disclosure will be described.

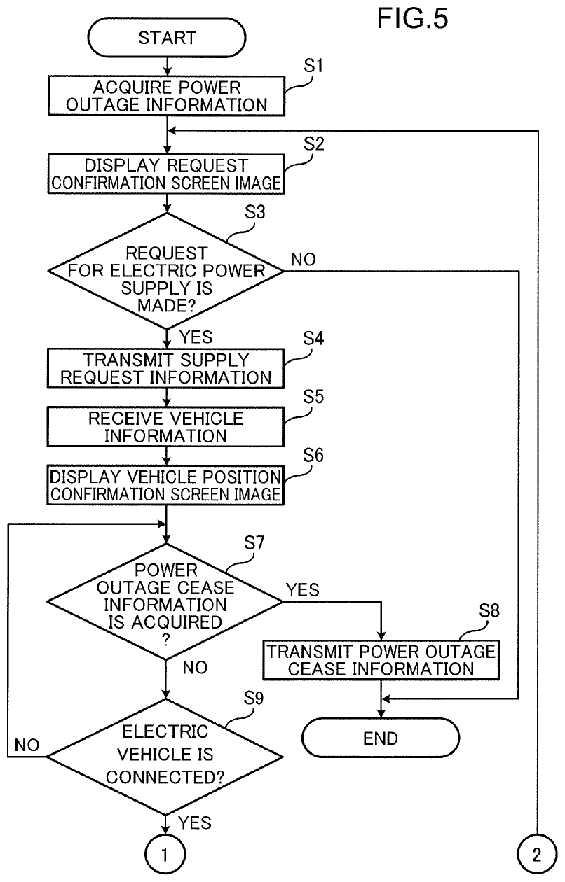

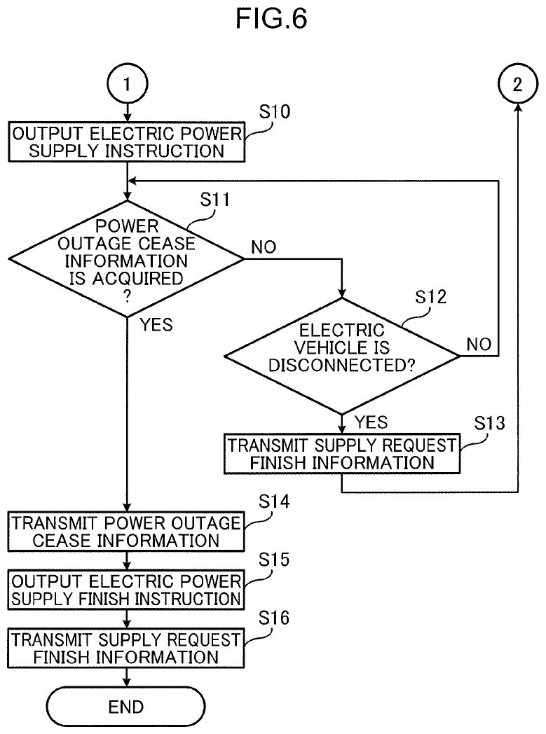

FIG. 5 is a first flowchart explaining the operation by the electric power supply controller in the first embodiment of the disclosure. FIG. 6 is a second flowchart explaining the operation by the electric power supply controller in the first embodiment of the disclosure.

First, in step S1, the power outage information acquisition section 171 acquires, from the power distribution board 103, power outage information indicating power outage of the house 1.

Subsequently, in step S2, the request confirmation display control section 172 causes the display part 13 to display a request confirmation screen image for allowing a resident to confirm whether to make a request for an electric power supply to the house 1 having the power outage.

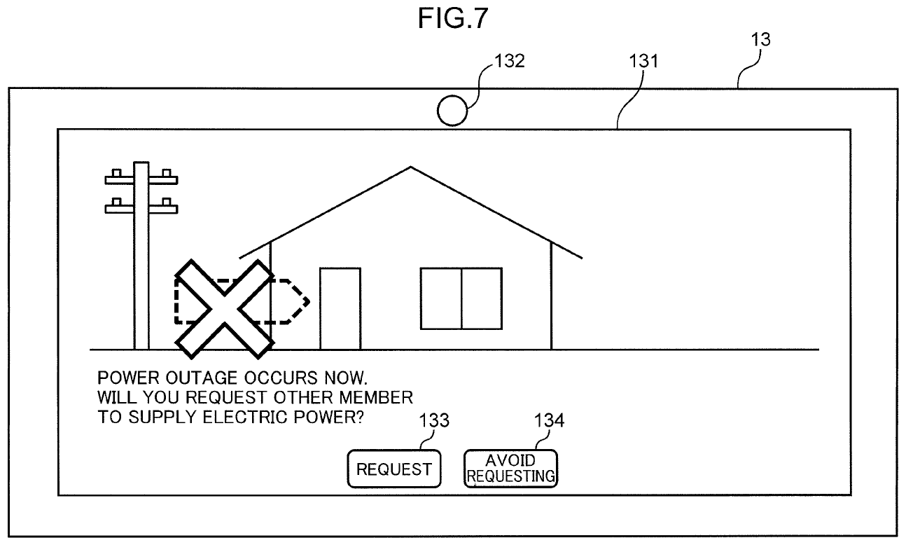

FIG. 7 shows an example of the request confirmation screen image in the first embodiment.

The display part 13 is located on a wall of a specific room (e.g., living room) in the house 1. The display part 13 displays a request confirmation screen image 131 thereon. The display part 13 may include an indicator 132 for notifying the resident of an occurrence of power outage in the house 1. The indicator 132 includes, for example, an LED (Light Emitting Diode) to be turned on, on the occurrence of the power outage in the house 1.

As shown in FIG. 7, the request confirmation screen image 131 is aimed at notifying the resident of the occurrence of the power outage in the house 1. The request confirmation screen image 131 includes a first button 133 and a second button 134 for receiving an input as to whether to request other member to supply electric power to the house 1. The other member represents a resident of other house preregistered in the user DB 241 of the server 2, and corresponds to a user of an associated electric vehicle. The first button 133 is touched to make the request for the electric power supply to the house 1. The second button 134 is touched to avoid the request for the electric power supply to the house 1.

Although the display part 13 is disposed in the house 1 in the first embodiment, the disclosure is not particularly limited thereto, and the display part may be included in a terminal, such as a smartphone, owned by the resident of the house 1.

Referring back to FIG. 5, next, in step S3, the request confirmation display control section 172 determines whether the request for the electric power supply to the house 1 having the power outage is made. The input part 14 receives, on the request confirmation screen image 131, an input by the resident as to whether to make the request for the electric power supply to the house 1 having the power outage. On the request confirmation screen image 131, the resident of the house 1 touches the first button 133 to request the other member to supply the electric power to the house 1 or touches the second button 134 to avoid requesting the other member to supply the electric power to the house 1.

Here, the process is finished when it is determined that no request for the electric power supply to the house 1 having the power outage is made (NO in step S3). Specifically, the process is finished in response to the touching of the second button 134 to avoid requesting the other member to supply the electric power to the house 1 on the request confirmation screen image 131.

Contrarily, when it is determined that the request for the electric power supply to the house 1 having the power outage is made (YES in step S3), the supply request information transmitting section 121 transmits, to the server 2, supply request information about the request for the electric power to the house 1 having the power outage in step S4. The supply request information is transmitted to the server 2 in response to the touching of the first button 133 to request the other member to supply the electric power to the house 1 on the request confirmation screen image 131.

Although the request confirmation screen image 131 is displayed for allowing the resident to confirm whether to make the request for the electric power supply to the house 1 having the power outage, and the supply request information is transmitted to the server 2 when the request for the electric power supply to the house 1 having the power outage is made in the first embodiment, this disclosure is not particularly limited thereto. The supply request information transmitting section 121 may automatically transmit the supply request information to the server 2 when the power outage information is acquired.

Then, in step S5, the vehicle information receiving section 122 receives, from the server 2, vehicle information including a current position of the electric vehicle 3 owned by the user showing acceptance of the electric power supply to the house 1 having the power outage. The vehicle information may include a time required for the electric vehicle 3 to reach the house 1 in addition to the current position of the electric vehicle 3. The vehicle information may include a vehicle type of the electric vehicle 3 and a color of the electric vehicle 3.

Subsequently, in step S6, the vehicle information display control section 173 causes the display part 13 to display, based on the vehicle information received by the vehicle information receiving section 122, a vehicle position confirmation screen image showing the current position of the electric vehicle 3 traveling to the house 1.

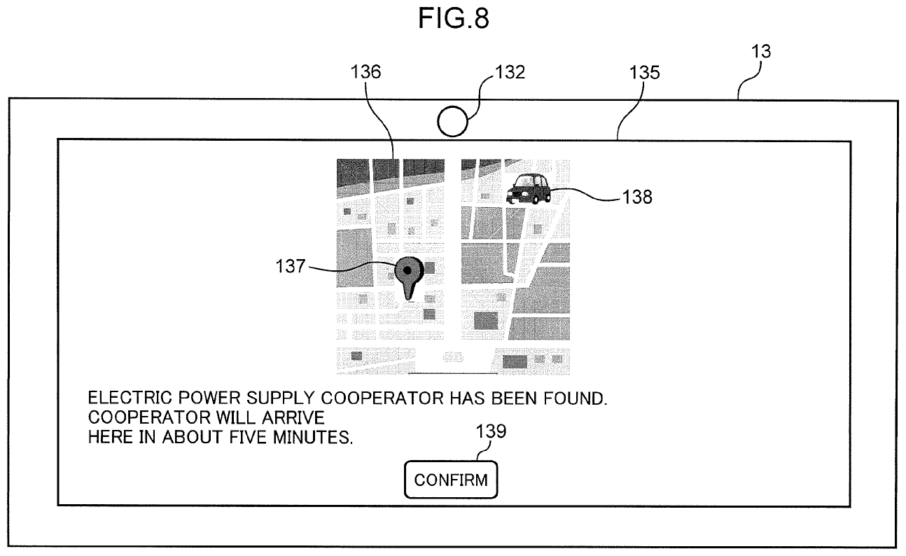

FIG. 8 shows an example of the vehicle position confirmation screen image in the first embodiment.

The display part 13 displays a vehicle position confirmation screen image 135 thereon. As shown in FIG. 8, the vehicle position confirmation screen image 135 is aimed at giving notification about a found electric power supply cooperator and about a time required for an associated electric vehicle 3 to reach the house 1. The vehicle position confirmation screen image 135 includes a map image 136 showing a periphery of the house 1. The map image 136 contains a location 137 of the house 1 and a position 138 of the electric vehicle 3. The resident of the house 1 can confirm the current position of the electric vehicle 3 by checking the position 138 of the electric vehicle 3 on the map image 136.

The vehicle position confirmation screen image 135 may include a button 139 for notifying that the resident of the house 1 confirms the traveling of the electric vehicle 3 to the house 1. Information indicating the confirmation by the resident of the house 1 about the traveling of the electric vehicle 3 to the house 1 may be transmitted to the server 2 in response to touching of the button 139. The server 2 then may notify the terminal 4 of the confirmation by the resident of the house 1 about the traveling of the electric vehicle 3 to the house 1.

Referring back to FIG. 5, next, in step S7, the power outage cease information acquisition section 174 determines whether power outage cease information indicating that the power outage of the house 1 has ceased is received from the power distribution board 103. In the case where the power outage of the house has ceased, the power distribution board 103 outputs the power outage cease information to the electric power supply controller 101. Here, when it is determined that the power outage cease information is acquired (YES in step S7), the power outage cease information transmitting section 123 transmits, to the server 2, the power outage cease information indicating that the power outage of the house 1 has ceased in step S8.

Contrarily, when it is determined that the power outage cease information is not acquired (NO in step S7), the electric power supply control section 176 determines whether the electric vehicle 3 is connected to the charging and discharging device 104 in step S9. The vehicle connection detecting section 175 detects connection of the electric vehicle 3 to the charging and discharging device 104. Here, when it is determined that the electric vehicle 3 is not connected to the charging and discharging device 104 (NO in step S9), the process returns to step S7.

Contrarily, when it is determined that the electric vehicle 3 is connected to the charging and discharging device 104 (YES in step S9), the electric power supply control section 176 outputs, to the electric vehicle 3, an electric power supply instruction to start the electric power supply by the electric vehicle 3 in step S10. When the electric vehicle 3 receives an input of the electric power supply instruction, the electric vehicle 3 supplies electric power to the loader 105 via the power distribution board 103.

Subsequently, in step S11, the power outage cease information acquisition section 174 determines whether the power outage cease information indicating that the power outage of the house 1 has ceased is acquired from the power distribution board 103. Here, when it is determined that the power outage cease information is not acquired (NO in step S11), the electric power supply control section 176 determines whether the electric vehicle 3 is disconnected from the charging and discharging device 104 in step S12. The vehicle connection detecting section 175 detects disconnection of the electric vehicle 3 from the charging and discharging device 104. Here, when it is determined that the electric vehicle 3 is not disconnected from the charging and discharging device 104 (NO in step S12), the process returns to step S11.

Contrarily, when it is determined that the electric vehicle 3 is disconnected from the charging and discharging device 104 (YES in step S12), the supply request finish information transmitting section 124 transmits supply request finish information to the server 2 in step S13. At this time, the house 1 still has the power outage under non-acquisition of the power outage cease information. Therefore, the process having undergone step S13 returns to step S2. In step S2, the request confirmation display control section 172 causes the display part 13 to display a request confirmation screen image thereon. In this manner, the resident confirms whether to make another request for an electric power supply to the house 1 having the power outage.

By contrast, when it is determined that the power outage cease information is acquired (YES in step S11), the power outage cease information transmitting section 123 transmits, to the server 2, power outage cease information indicating that the power outage of the house 1 has ceased in step S14.

Next, in step S15, the electric power supply control section 176 outputs, to the electric vehicle 3, an electric power supply finish instruction to finish the electric power supply by the electric vehicle 3. When the electric vehicle 3 receives an input of the electric power supply finish instruction, the electric vehicle 3 stops the electric power supply. Thereafter, the electric vehicle 3 is disconnected from the charging and discharging device 104.

Then, in step S16, the supply request finish information transmitting section 124 transmits the supply request finish information to the server 2.

Next, an operation by the server 2 in the first embodiment of the disclosure will be described.

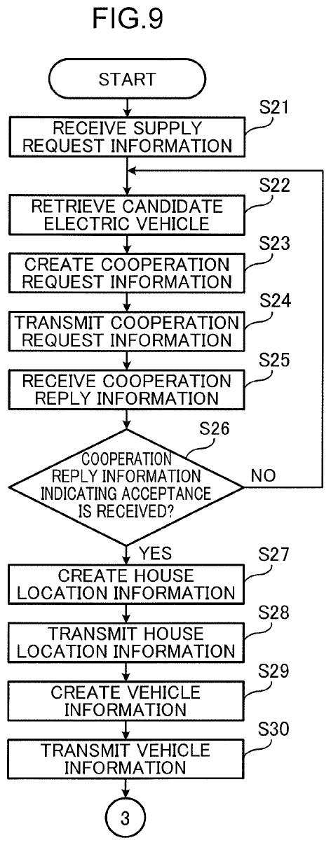

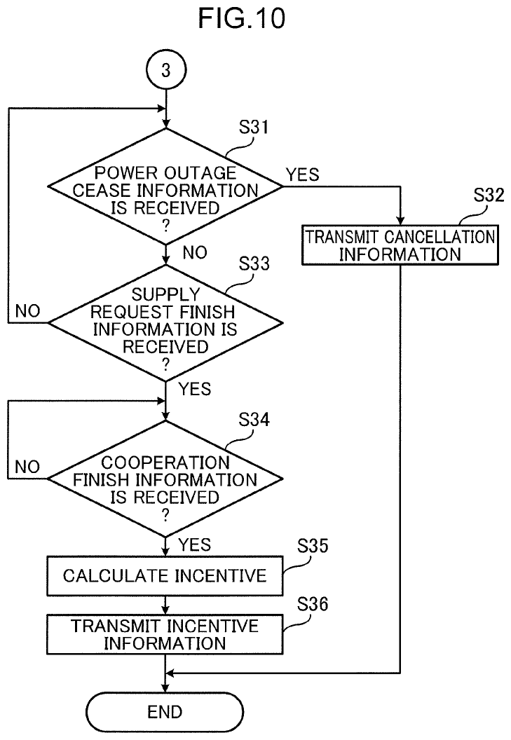

FIG. 9 is a first flowchart explaining the operation by the server in the first embodiment of the disclosure. FIG. 10 is a second flowchart explaining the operation by the server in the first embodiment of the disclosure.

First, in step S21, the supply request information receiving section 211 receives supply request information transmitted by the electric power supply controller 101.

Subsequently, in step S22, the candidate vehicle retrieving section 231 retrieves, with reference to the user DB 241, a candidate electric vehicle that enables an electric power supply to the house 1 among electric vehicles associated with other houses different from the house 1 having the power outage. Here, the candidate vehicle retrieving section 231 retrieves a candidate electric vehicle having a shortest travel distance from a current position thereof to the house 1 among electric vehicles each having a larger residual amount in subtraction of a travel power consumptive amount from a battery remaining amount thereof than a predetermined amount.

The candidate vehicle retrieving section 231 retrieves one candidate electric vehicle after another. Specifically, first, the candidate vehicle retrieving section 231 retrieves a candidate electric vehicle having a shortest travel distance from a current position thereof to the house 1 among electric vehicles each having a larger residual amount in subtraction of a travel power consumptive amount from a battery remaining amount thereof than a predetermined amount. Then, in a case where a request for the electric power supply is not accepted as a result of requesting the retrieved candidate electric vehicle to supply the electric power, the candidate vehicle retrieving section 231 retrieves another candidate vehicle having a second shortest travel distance from a current position thereof to the house 1 among the electric vehicles each having a larger residual amount in subtraction of the travel power consumptive amount from the battery remaining amount thereof than the predetermined amount. In this manner, the candidate vehicle retrieving section 231 continues the candidate electric vehicle retrieval until the request for the electric power supply is accepted.

The candidate vehicle retrieving section 231 may retrieve a plurality of candidate electric vehicles. Specifically, first, the candidate vehicle retrieving section 231 may retrieve a predetermined number of electric vehicles as candidate electric vehicles in order of shortest travel distance from a current position of each vehicle to the house 1 among electric vehicles each providing a larger residual amount in subtraction of a travel power consumptive amount from a battery remaining amount thereof than a predetermined amount. Then, the cooperation request information transmitting section 212 may transmit cooperation request information to the electric vehicles in the order of the shortest travel distance among the predetermined number of retrieved candidate electric vehicles.

Subsequently, in step S23, the cooperation request information creating section 232 creates cooperation request information about a request for the electric power supply from the candidate electric vehicle to the house 1. The candidate electric vehicle in the first embodiment corresponds to the electric vehicle 3.

Next, in step S24, the cooperation request information transmitting section 212 transmits the cooperation request information created by the cooperation request information creating section 232 to the terminal 4 associated with the candidate electric vehicle (electric vehicle 3) retrieved by the candidate vehicle retrieving section 231.

Then, in step S25, the cooperation reply information receiving section 213 receives, from the terminal 4, cooperation reply information indicating acceptance or unacceptance of the electric power supply to the house 1.

Further, in step S26, the house location information creating section 233 determines whether the cooperation reply information indicating acceptance is received. Here, when it is determined that cooperation reply information indicating unacceptance is received (NO in step S26), the process returns to step S22, and another candidate electric vehicle is retrieved.

Contrarily, when it is determined that the cooperation reply information indicating the acceptance is received (YES in step S26), the house location information creating section 233 creates house location information about a location of the house 1 having the power outage in step S27.

Subsequently, in step S28, the house location information transmitting section 214 transmits, to the terminal 4, the house location information created by the house location information creating section 233.

Although the cooperation request information transmitting section 212 transmits the cooperation request information to the single terminal 4 associated with the single candidate electric vehicle retrieved by the candidate vehicle retrieving section 231 in the embodiment, the disclosure is not particularly limited thereto. The cooperation request information transmitting section 212 may transmit the cooperation request information to a plurality of terminals 4 respectively associated with a plurality of candidate electric vehicles retrieved by the candidate vehicle retrieving section 231. Then, the house location information transmitting section 214 may transmit the house location information to a specific terminal 4 having firstly sent cooperation reply information indicating acceptance among the terminals 4.

Next, in step S29, the vehicle information creating section 234 creates vehicle information including a current position of the candidate electric vehicle (electric vehicle 3).

Subsequently, in step S30, the vehicle information transmitting section 215 transmits, to the electric power supply controller 101, the vehicle information created by the vehicle information creating section 234.

Then, in step S31, the cancellation instructing section 235 determines whether power outage cease information indicating that the power outage of the house 1 has ceased is received from the electric power supply controller 101. The power outage cease information receiving section 216 receives the power outage cease information from the electric power supply controller 101.

Here, when it is determined that the power outage cease information is received (YES in step S31), the cancellation information transmitting section 217 transmits, to the terminal 4, cancellation information about cancellation of the request for the electric power supply to the house 1 in step S32.

Contrarily, when it is determined that the power outage cease information is not received (NO in step S31), the incentive calculating section 236 determines whether supply request finish information about finish of the electric power supply from the electric vehicle 3 to the house 1 is received from the electric power supply controller 101 in step S33. The supply request finish information receiving section 218 receives the supply request finish information from the electric power supply controller 101. Here, when it is determined that the supply request finish information is not received (NO in step S33), the process returns to step S31.

Contrarily, when it is determined that the supply request finish information is received (YES in step S33), the incentive calculating section 236 determines whether cooperation finish information about the finish of the electric power supply from the electric vehicle 3 to the house 1 is received from the terminal 4 in step S34. The cooperation finish information receiving section 219 receives the cooperation finish information from the terminal 4. Here, when it is determined that the cooperation finish information is not received (NO in step S34), step S34 is repeated until the cooperation finish information is received.

Contrarily, when it is determined that the cooperation finish information is received (YES in step S34), the incentive calculating section 236 calculates an incentive to be given to a user of the candidate electric vehicle (electric vehicle 3) in step S35.

Subsequently, in step S36, the incentive information transmitting section 220 transmits, to the terminal 4, incentive information about the incentive calculated by the incentive calculating section 236.

As described above, an electric vehicle 3 (candidate electric vehicle) that enables an electric power supply to the house 1 is retrieved among electric vehicles associated with other houses different from the house 1 having the power outage. Besides, when a user of the retrieved electric vehicle 3 accepts the electric power supply to the house 1, location information about the location of the house 1 is transmitted to the terminal 4 associated with the retrieved electric vehicle 3. Owing to the presentation of the location of the house 1 on the terminal 4 having received the location information, the user of the electric vehicle 3 allows the electric vehicle 3 to travel to the house 1. Then, the storage battery 31 of the electric vehicle 3 and the house 1 are connected to each other to achieve the electric power supply from the electric vehicle 3 to the house 1.

It is seen from this perspective that the electric vehicle 3 that enables the electric power supply travels to the house 1 having the power outage to supply the electric power from the electric vehicle 3 to the house 1 having the power outage, and therefore achieves the electric power supply to the house 1 even in the power outage.

Next, an operation by the terminal 4 in the first embodiment of the disclosure will be described.

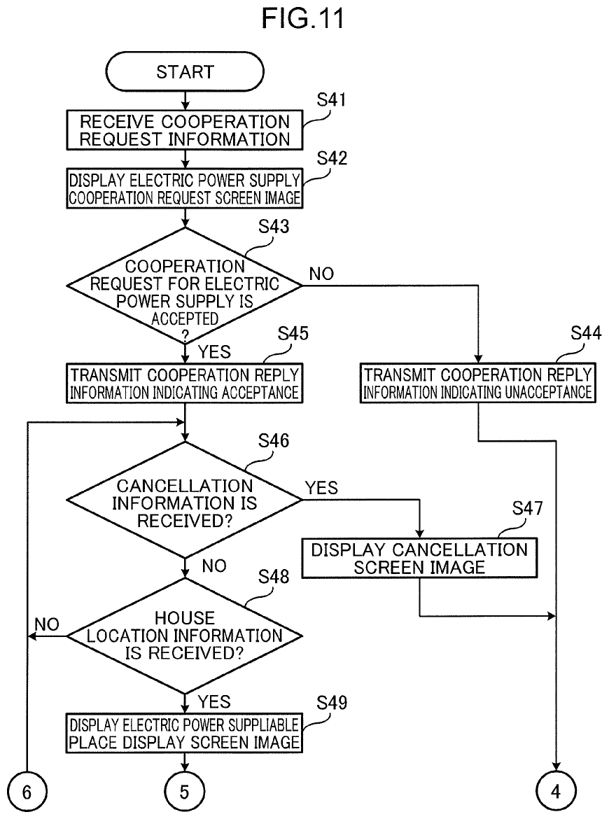

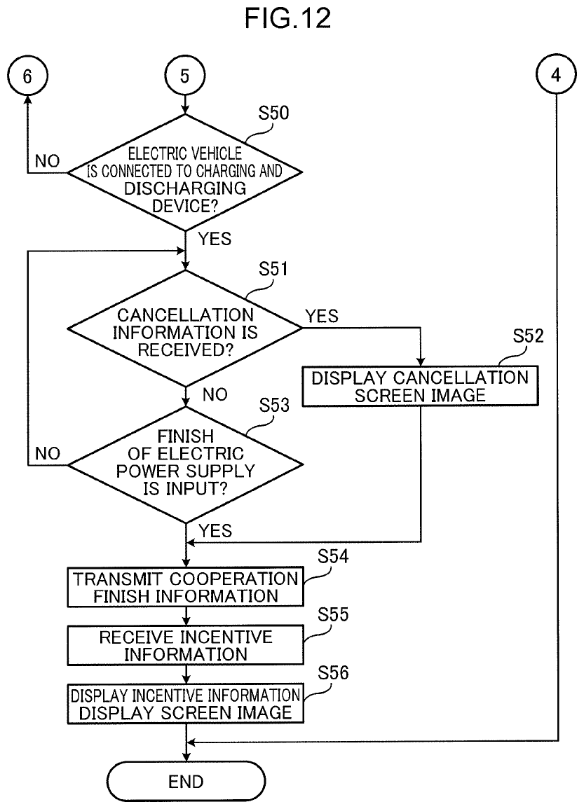

FIG. 11 is a first flowchart explaining the operation by the terminal in the first embodiment of the disclosure. FIG. 12 is a second flowchart explaining the operation by the terminal in the first embodiment of the disclosure.

First, in step S41, the cooperation request information receiving section 411 receives cooperation request information transmitted by the server 2. The cooperation request information includes an approximate address of the house 1 having the power outage and a distance from the house 1 having the power outage to the electric vehicle 3.

Next, in step S42, the cooperation request display control section 451 causes the display part 43 to display, based on the cooperation request information received by the cooperation request information receiving section 411, an electric power supply cooperation request screen image for receiving acceptance or unacceptance of the cooperation request for the electric power supply to the house 1 having the power outage.

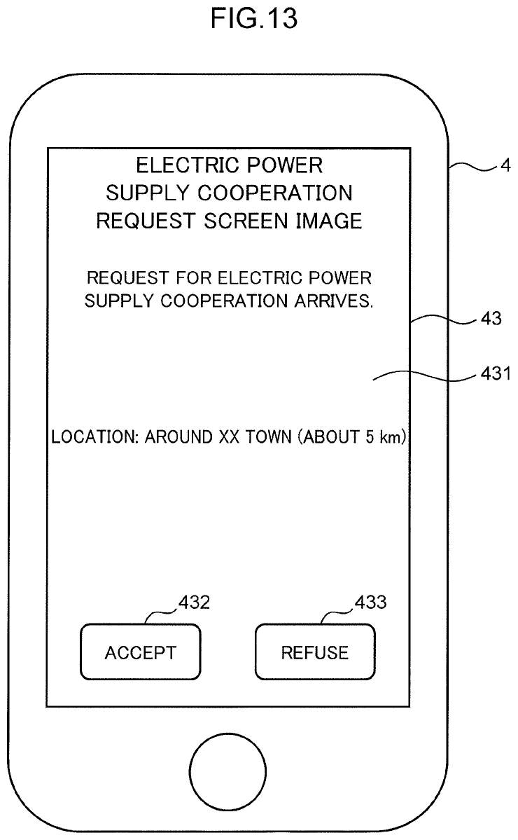

FIG. 13 shows an example of the electric power supply cooperation request screen image in the first embodiment.

The display part 43 displays an electric power supply cooperation request screen image 431 thereon. As shown in FIG. 13, the electric power supply cooperation request screen image 431 is aimed at giving notification about the request for the electric power supply and the distance to the house 1. The electric power supply cooperation request screen image 431 includes a first button 432 and a second button 433 for receiving an input of acceptance or unacceptance of the cooperation request for the electric power supply to the house 1. The first button 432 is touched to show the acceptance of the cooperation request for the electric power supply to the house 1. The second button 433 is touched to show the unacceptance of the cooperation request for the electric power supply to the house 1.

Referring back to FIG. 11, next, in step S43, the cooperation request display control section 451 determines whether the cooperation request for the electric power supply to the house 1 having the power outage is accepted. The input part 44 receives, on the electric power supply cooperation request screen image 431, an input by the user about the acceptance or the unacceptance of the cooperation request for the electric power supply to the house 1 having the power outage. On the electric power supply cooperation request screen image 431, the user of the electric vehicle 3 touches the first button 432 to show the acceptance of the cooperation request for the electric power supply to the house 1 having the power outage or touches the second button 433 to show the unacceptance of the cooperation request for the electric power supply to the house 1 having the power outage.

Here, when it is determined that the cooperation request for the electric power supply is not accepted (NO in step S43), the cooperation reply information transmitting section 412 transmits, to the server 2, cooperation reply information indicating the unacceptance of the electric power supply to the house 1 in step S44. Then, the process is finished.

Contrarily, when it is determined that the cooperation request for the electric power supply is accepted (YES in step S43), the cooperation reply information transmitting section 412 transmits, to the server 2, cooperation reply information indicating the acceptance of the electric power supply to the house 1 in step S45.

Further, in step S46, the cancellation information display control section 453 determines whether cancellation information transmitted by the server 2 is received. The cancellation information receiving section 414 receives the cancellation information transmitted by the server 2. Here, when it is determined that the cancellation information is received (YES in step S46), the cancellation information display control section 453 causes the display part 43 to display a cancellation screen image showing cancellation of the request for the electric power supply to the house 1 in step S47. The display part 43 displays the cancellation screen image thereon. Then, the process is finished.

Contrarily, when it is determined that the cancellation information is not received (NO in step S46), the electric power suppliable place display control section 452 determines whether house location information transmitted by the server 2 is received in step S48. The house location information receiving section 413 receives the house location information transmitted by the server 2. Here, when it is determined that the house location information is not received (NO in step S48), the process returns to step S46.

Contrarily, when it is determined that the house location information is received (YES in step S48), the electric power suppliable place display control section 452 causes the display part 43 to display an electric power suppliable place display screen image showing the location of the house 1 having the power outage and the name of the resident of the house 1 in step S49.

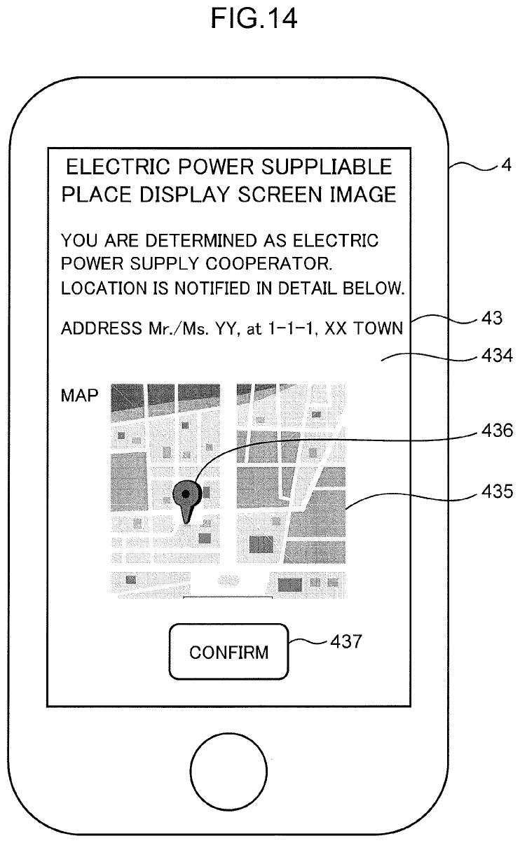

FIG. 14 shows an example of the electric power suppliable place display screen image in the first embodiment.

The display part 43 displays an electric power suppliable place display screen image 434 thereon. As shown in FIG. 14, the electric power suppliable place display screen image 434 is aimed at giving notification about a determination on the user as an electric power supply cooperator, and further giving notification about the address of the house 1 being a destination of electric vehicle 3, and the name of the resident of the house 1. The electric power suppliable place display screen image 434 includes a map image 435 showing a periphery of the house 1. The map image 435 contains a location 436 of the house 1. The user of the electric vehicle 3 can confirm the destination of the electric vehicle 3 by checking the location 436 of the house 1 on the map image 435.

The electric power suppliable place display screen image 434 may include a button 437 for notifying that the user of the electric vehicle 3 confirms that the user is determined as the electric power supply cooperator. Information indicating the confirmation by the user of the electric vehicle 3 that the user is determined as the electric power supply cooperator may be transmitted to the server 2 in response to touching of the button 437. Then, the server 2 may transmit the vehicle information to the electric power supply controller 101 upon receiving the information indicating the confirmation by the user of the electric vehicle 3 that the user is determined as the electric power supply cooperator.

The user of the electric vehicle 3 checks the electric power suppliable place display screen image 434 displayed on the terminal 4. The user of the electric vehicle 3 drives the electric vehicle 3 to travel to the house 1 as displayed on the electric power suppliable place display screen image 434. The user having reached the house 1 connects the storage battery 31 of the electric vehicle 3 to the charging and discharging device 104 disposed in the house 1.

Although the electric vehicle 3 is driven by the user in the first embodiment, the disclosure is not particularly limited thereto. The electric vehicle 3 may be an autonomous vehicle. In this case, the electric vehicle 3 may acquire the location of the house 1 from the server 2 and automatically travel to the house 1 after the terminal 4 transmits the cooperation reply information indicating the acceptance. Further, when the electric vehicle 3 reaches the house 1, the display part 13 of the electric power supply controller 101 may notify the resident of the house 1 that the electric vehicle 3 has reached the house 1. The resident of the house 1 may connect the storage battery 31 of the electric vehicle 3 having reached to the charging and discharging device 104 disposed in the house 1.

Next, in step S0, the vehicle connection determining section 454 determines whether the electric vehicle 3 is connected to the charging and discharging device 104. The vehicle connection information receiving section 415 receives, from the electric vehicle 3, vehicle connection information indicating connection of the electric vehicle 3 to the charging and discharging device 104. When the vehicle connection information receiving section 415 receives the vehicle information, the vehicle connection determining section 454 determines that the electric vehicle 3 is connected to the charging and discharging device 104. Here, when it is determined that the electric vehicle 3 is not connected to the charging and discharging device 104 (NO in step S50), the process returns to step S46.

Contrarily, when it is determined that the electric vehicle 3 is connected to the charging and discharging device 104 (YES in step S50), the cancellation information display control section 453 determines, in step S51, whether cancellation information transmitted by the server 2 is received. The cancellation information receiving section 414 receives the cancellation information transmitted by the server 2. Here, when it is determined that the cancellation information is received (YES in step S51), the cancellation information display control section 453 causes the display part 43 to display a cancellation screen image showing cancellation of the request for the electric power supply to the house 1 in step S52. The display part 43 displays the cancellation screen image thereon. Then, the process proceeds to step S54.

Contrarily, when it is determined that the cancellation information is not received (NO in step S51), the cooperation finish receiving section 455 determines, in step S53, whether finish of the electric power supply from the electric vehicle 3 to the house 1 is input by the user. At this time, the cooperation finish receiving section 455 causes the display part 43 to display a selection receipt screen image for receiving selection by the user as to whether to finish the electric power supply from the electric vehicle 3 to the house 1. The user inputs, on the displayed selection receipt screen image, selection as to whether to finish the electric power supply from the electric vehicle 3 to the house 1. Here, when it is determined that the finish of the electric power supply is not input by the user (NO in step S53), the process returns to step S51.

Contrarily, when it is determined that the finish of the electric power supply is input by the user (YES in step S53), the cooperation finish information transmitting section 416 transmits, to the server 2, cooperation finish information about finish of the electric power supply from the electric vehicle 3 to the house 1 in step S54.

The user disconnects the storage battery 31 of the electric vehicle 3 and the charging and discharging device 104 from each other after inputting, on the displayed selection receipt screen image, the finish of the electric power supply from the electric vehicle 3 to the house 1. Further, the user drives the electric vehicle 3 to leave the house 1.

In the case where the electric vehicle 3 is an autonomous vehicle, the server 2 may notify the electric power supply controller 101 of the input of the finish of the electric power supply by the user when receiving the cooperation finish information. The electric power supply controller 101 may notify the resident of the house 1 that the finish of the electric power supply is input by the user. The resident of the house 1 disconnects the storage battery 31 of the electric vehicle 3 and the charging and discharging device 104 from each other. When the storage battery 31 and the charging and discharging device 104 are disconnected from each other, the electric vehicle 3 may automatically travel back to the house to which the electric vehicle belongs.

Next, in step S55, the incentive information receiving section 417 receives incentive information transmitted by the server 2.

Subsequently, in step S56, the incentive information display control section 456 causes the display part 43 to display an incentive information display screen image showing the incentive information received by the incentive information receiving section 417.

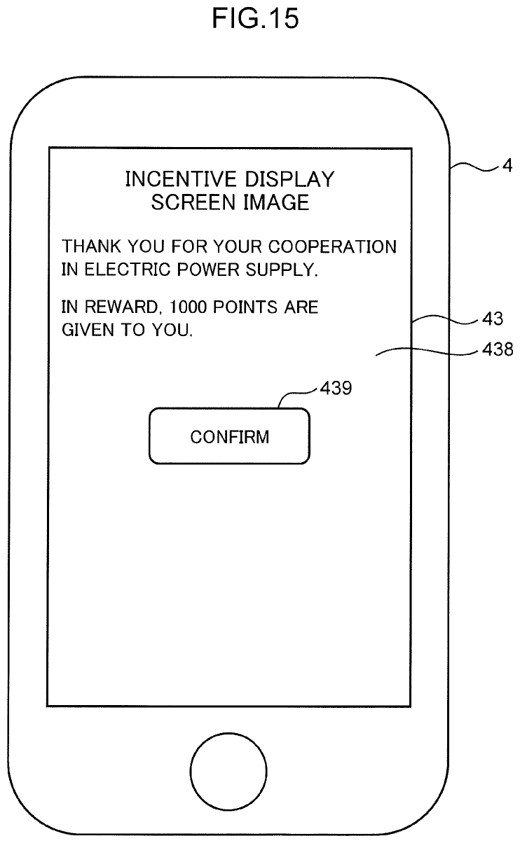

FIG. 15 shows an example of the incentive information display screen image in the first embodiment.

The display part 43 displays an incentive information display screen image 438 thereon. As shown in FIG. 15, the incentive information display screen image 438 is aimed at notifying the user of an incentive to be given thereto. For instance, the incentive includes a predetermined number of points to be given to the user of the electric vehicle 3 for the electric power supply to the house 1.

The incentive information display screen image 438 may further include a button 439 for notifying that the user of the electric vehicle 3 confirms the incentive. The information indicating the confirmation of the incentive by the user of the electric vehicle 3 may be sent to the server 2 in response to touching of the button 439.

The electric power supply cooperation request screen image 431 shown in FIG. 13 may show a prospective incentive to be given to the user of the electric vehicle 3 for the electric power supply to the house 1. In this case, the cooperation request information transmitted by the server 2 may include incentive information about the prospective incentive to be given to the user of the electric vehicle 3 for the electric power supply to the house 1. The server 2 may calculate, as the prospective incentive, a past average value of incentives given in accordance with a distance from the electric vehicle 3 to the house 1 having the power outage. A way of calculating the prospective incentive is not particularly limited. Accordingly, such notification of an incentive prospected to be given to the user of the electric vehicle 3 in future on the electric power supply cooperation request screen image 431 encourages the user to easily accept the electric power supply to the house 1.

Next, a modification of the first embodiment will be described. Although no electric vehicle is parked at the house 1 in the first embodiment, a specific electric vehicle is parked at the house 1 in the modification of the first embodiment.

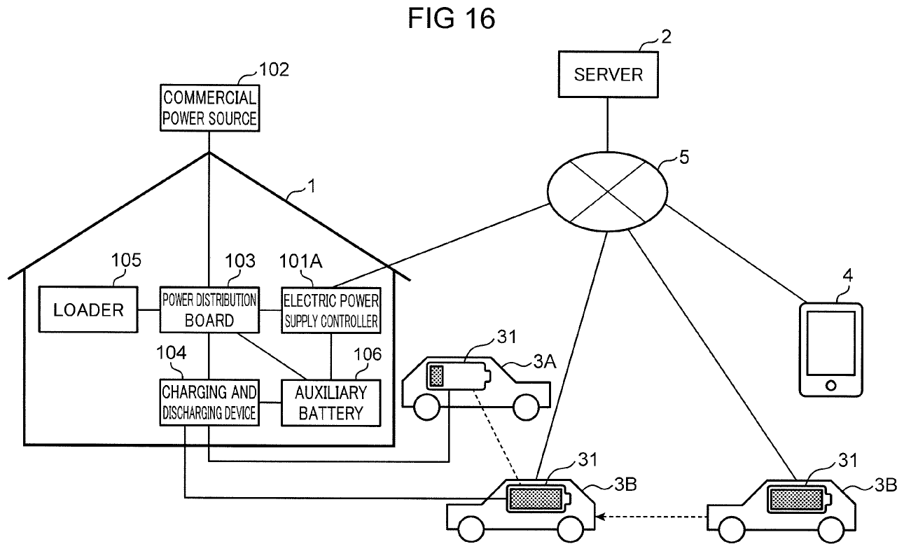

FIG. 16 shows an overall configuration of an information processing system in the modification of the first embodiment of the disclosure.

The information processing system shown in FIG. 16 includes an electric power supply controller 101A, a server 2, a first electric vehicle 3A, a second electric vehicle 3B, and a terminal 4.

The electric power supply controller 101A is disposed in the house 1. A power distribution board 103, a charging and discharging device 104, a loader 105, and an auxiliary battery 106 are disposed in the house 1, in addition to the electric power supply controller 101A.

In the modification of the first embodiment, elements which are the same as those in the first embodiment are given the same reference signs and numerals, and thus explanation therefor will be omitted.

The first electric vehicle 3A is owned by a resident of the house 1. The first electric vehicle 3A includes a storage battery 31 mounted thereon and travels by supplying electric power charged in the storage battery 31 to an electric motor. The first electric vehicle 3A further supplies the electric power stored in the storage battery 31 to the house 1. The storage battery 31 of the first electric vehicle 3A is connected to the charging and discharging device 104 disposed in the house 1. The charging and discharging device 104 charges the storage battery 31 of the first electric vehicle 3A, and discharges the storage battery 31 of the first electric vehicle 3A to supply the electric power from the storage battery 31 to the power distribution board 103.

The charging and discharging device 104 acquires a battery remaining amount of the storage battery 31 of the first electric vehicle 3A. The charging and discharging device 104 outputs the acquired battery remaining amount to the electric power supply controller 101A via the power distribution board 103.

The second electric vehicle 3B is owned by a resident of other house different from the house 1. The second electric vehicle 3B has the same configuration as that of the electric vehicle 3 in the first embodiment. The terminal 4 is owned by a user who owns the second electric vehicle 3B.

Hereinafter, a schematic operation by the information processing system in the modification of the first embodiment will be described.

When the house 1 has power outage, the electric power supply controller 101A disposed in the house 1 switches an electric power supply source from a commercial power supply source 102 to the storage battery 31 of the first electric vehicle 3A. Besides, the electric power supply controller 101A calculates an electric power suppliable time indicating a time available for the first electric vehicle 3A in the state of supplying the electric power to the house 1 to continue the supplying of electric power to the house 1. Further, the electric power supply controller 101A transmits, to the server 2, supply request information about a request for an electric power supply to the house 1 having the power outage. At this time, the supply request information includes the electric power suppliable time.

The server 2 retrieves, when receiving the supply request information, a candidate electric vehicle that is associated with other house different from the house 1 having the power outage and enables the electric power supply to the house 1 among electric vehicles each having a possibility of reaching the house 1 within the electric power suppliable time. The candidate electric vehicle retrieved here corresponds to the second electric vehicle 3B. The server 2 then transmits, to the terminal 4 associated with the retrieved second electric vehicle 3B, cooperation request information about a request for the electric power supply from the electric vehicle 3B to the house 1. The terminal 4 transmits, to the server 2, cooperation reply information indicating acceptance or unacceptance of the electric power supply to the house 1 when receiving the cooperation request information. Here, the cooperation reply information indicating the acceptance is transmitted to the server 2.

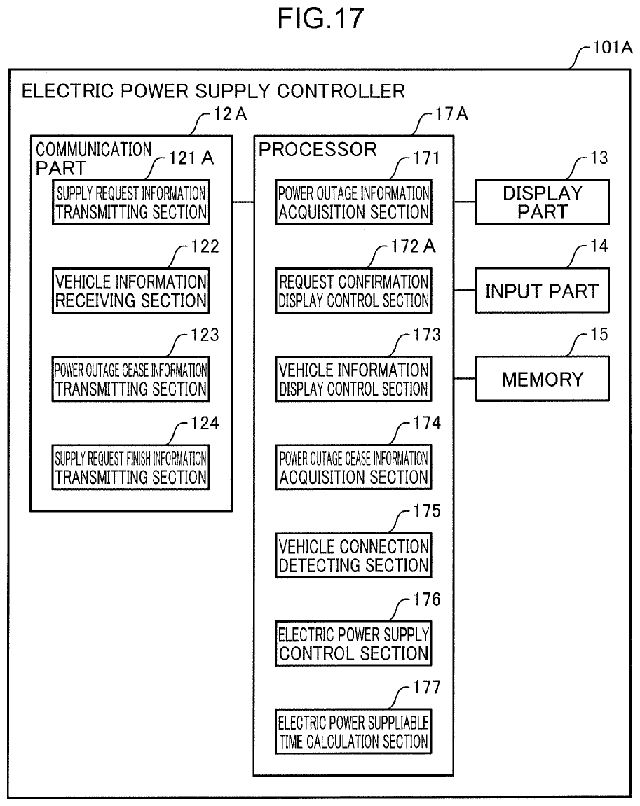

The server 2 transmits house location information about a location of the house 1 to the terminal 4 when receiving the cooperation reply information indicating the acceptance. The terminal 4 shows the received house location information to the user of the second electric vehicle 3B when receiving the house location information. The second electric vehicle 3B is driven by the user to travel to the house 1. When the second electric vehicle 3B reaches the house 1, the electric vehicle 3B is connected to the house 1 to supply the electric power from the second electric vehicle 3B to the house 1. In this manner, the loader 105 is available even in the house 1 having the power outage owing to the electric power supply by the second electric vehicle 3B. FIG. 17 shows a configuration of the electric power supply controller in the modification of the first embodiment of the disclosure.

The electric power supply controller 101A shown in FIG. 17 includes a communication part 12A, a display part 13, an input part 14, a memory 15, and a processor 17A.

The communication part 12A includes a supply request information transmitting section 121A, a vehicle information receiving section 122, a power outage cease information transmitting section 123, and a supply request finish information transmitting section 124.

The processor 17A includes a power outage information acquisition section 171, a request confirmation display control section 172A, a vehicle information display control section 173, a power outage cease information acquisition section 174, a vehicle connection detecting section 175, an electric power supply control section 176, and an electric power suppliable time calculating section 177.

When the power outage information acquisition section 171 acquires power outage information in a state of supplying the electric power to the house 1 by the first electric vehicle 3A, the electric power suppliable time calculating section 177 calculates an electric power suppliable time indicating a time available for the first electric vehicle 3A in the state of supplying the electric power to continue the supplying of the electric power to the house 1. At this time, the electric power suppliable time calculating section 177 acquires, from the power distribution board 103, a battery remaining amount of the storage battery 31 of the first electric vehicle 3A and a current power consumptive amount of the loader 105. The electric power suppliable time calculating section 177 calculates the electric power suppliable time, based on the battery remaining amount of the storage battery 31 of the first electric vehicle 3A and the current power consumptive amount of the loader 105.

The request confirmation display control section 172A causes the display part 13 to display a request confirmation screen image for allowing a user to confirm whether to make a request for an electric power supply to the house 1 having the power outage. At this time, the request confirmation screen image includes the electric power suppliable time.

The supply request information transmitting section 121A transmits, to the server 2, supply request information (first request information) about the request for the electric power supply to the house 1 having the power outage. The supply request information includes the electric power suppliable time. Specifically, in the case where the first electric vehicle 3A is in the state of supplying the electric power to the house 1, the supply request information transmitting section 121A transmits, to the server 2, an electric power suppliable time indicating a time available for the first electric vehicle 3A in the state of supplying the electric power to continue the supplying of the electric power to the house 1.

Next, a configuration of the server 2 in the modification of the first embodiment will be described. In the modification of the first embodiment, differences from the configuration of the server 2 in the first embodiment 1 as shown in FIG. 3 will be described.

The supply request information receiving section 211 receives, from the house 1 having the power outage among the plurality of houses, supply request information (first request information) about a request for an electric power supply to the house 1. The supply request information includes the electric power suppliable time. Specifically, in the case where the first electric vehicle 3A is in the state of supplying the electric power to the house 1, the supply request information receiving section 211 receives, from the house 1, an electric power suppliable time indicating a time available for the first electric vehicle 3A in the state of supplying the electric power to continue the supplying of the electric power to the house 1.

A candidate vehicle retrieving section 231 retrieves a candidate electric vehicle among electric vehicles each having a possibility of reaching the house 1 within the electric power suppliable time. The candidate vehicle retrieving section 231 calculates a travel time to the house 1 from a current position of each electric vehicle associated with other house different from the house 1 having the power outage. The candidate vehicle retrieving section 231 retrieves the candidate electric vehicle that enables the electric power supply to the house 1 among the electric vehicles each having the travel time falling within the electric power suppliable time.

The candidate vehicle retrieving section 231 may retrieve a candidate electric vehicle among electric vehicles each having a travel time falling within the electric power suppliable time and a battery remaining amount which is larger than a travel power consumptive amount required for the electric vehicle traveling from a current position thereof to a chargeable place via the house 1. Alternatively, the candidate vehicle retrieving section 231 may retrieve a candidate electric vehicle providing a largest residual amount in subtraction of a travel power consumptive amount from a battery remaining amount thereof. The chargeable place may be the house of the user of the electric vehicle, or a place where a charger is provided around the house 1.

The candidate vehicle retrieving section 231 may retrieve a candidate electric vehicle having a shortest travel time from a current position thereof to the house 1 or having a shortest travel distance from the current position thereof to the house 1 among electric vehicles each having a travel time falling within the electric power suppliable time. The candidate vehicle retrieving section 231 may retrieve a candidate electric vehicle having a shortest travel time from a current position thereof to the house 1 or having a shortest travel distance from the current position thereof to the house 1 among electric vehicles each having a travel time falling within the electric power suppliable time and a battery remaining amount which is larger than a travel power consumptive amount required for each electric vehicle traveling from a current position thereof to a chargeable place via the house 1.

The candidate vehicle retrieving section 231 may retrieve a candidate electric vehicle having a shortest travel time from a current position thereof to the house 1 or having a shortest travel distance from the current position thereof to the house 1 among electric vehicles each having a travel time falling within the electric power suppliable time and a residual amount in subtraction of a travel power consumptive amount from a battery remaining amount thereof, the residual amount being larger than a predetermined amount.

The candidate vehicle retrieving section 231 may retrieve a candidate electric vehicle providing a largest residual amount in subtraction of a travel power consumptive amount from a battery remaining amount thereof among electric vehicles each having a shorter travel time from a current position of thereof to the house 1 than a predetermined time, the travel time further falling within the electric power suppliable time. The candidate vehicle retrieving section 231 may retrieve a candidate electric vehicle having a largest residual amount in subtraction of a travel power consumptive amount from a battery remaining amount thereof among electric vehicles each having a travel time falling within the electric power suppliable time and a shorter travel distance from the current position thereof to the house 1 than a predetermined distance.

Next, an operation by the electric power supply controller 101A in the modification of the first embodiment of the disclosure will be described.

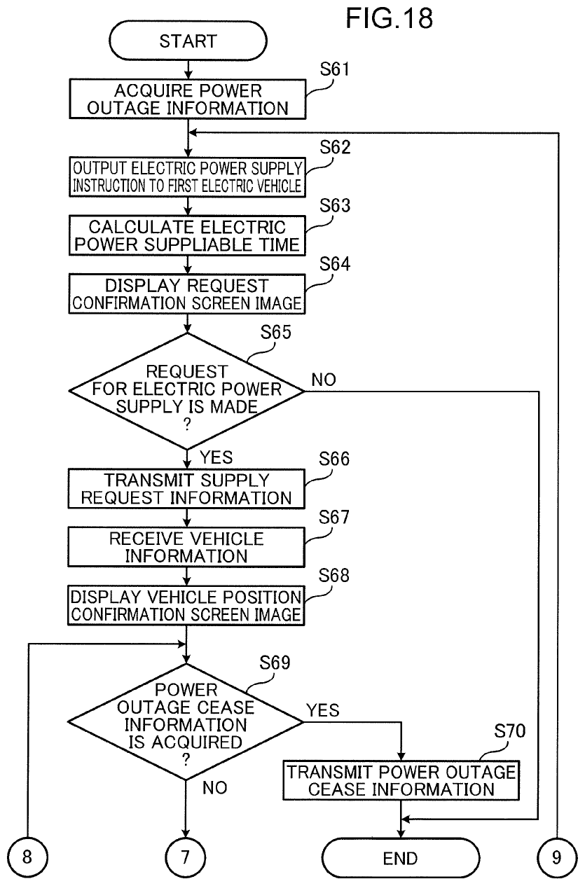

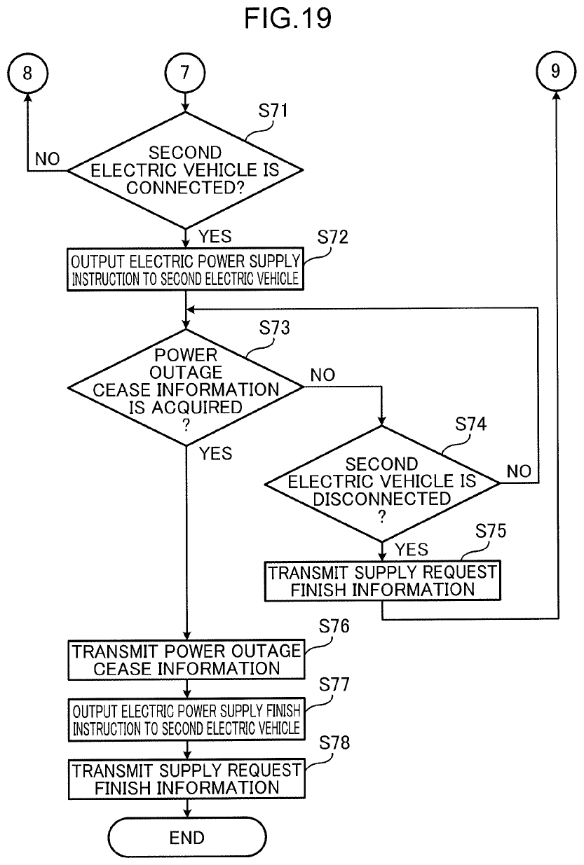

FIG. 18 is a first flowchart explaining the operation by the electric power supply controller in the modification of the first embodiment of the disclosure. FIG. 19 is a second flowchart explaining the operation by the electric power supply controller in the modification of the first embodiment of the disclosure.

First, in step S61, the power outage information acquisition section 171 acquires, from the power distribution board 103, power outage information indicating power outage of the house 1.

Next, in step S62, the electric power supply control section 176 outputs, to the first electric vehicle 3A, an electric power supply instruction to start the electric power supply by the first electric vehicle 3A. When the first electric vehicle 3A receives an input of the electric power supply instruction, the first electric vehicle 3A supplies the electric power to the loader 105 via the power distribution board 103.

Here, in the modification of the first embodiment, the electric power supply control section 176 may determine whether the first electric vehicle 3A is connected to the charging and discharging device 104. When the first electric vehicle 3A is connected to the charging and discharging device 104, the electric power supply control section 176 may output, to the first electric vehicle 3A, the electric power supply instruction to start the electric power supply by the first electric vehicle 3A. When the first electric vehicle 3A is not connected to the charging and discharging device 104, the process may proceed to step S64.

Subsequently, in step S63, the electric power suppliable time calculating section 177 calculates an electric power suppliable time indicating a time available for the first electric vehicle 3A in a state of supplying the electric power to continue the supplying of the electric power to the house 1.

Next, in step S64, the request confirmation display control section 172A causes the display part 13 to display a request confirmation screen image for allowing a resident to confirm whether to make a request for an electric power supply to the house 1 having the power outage.

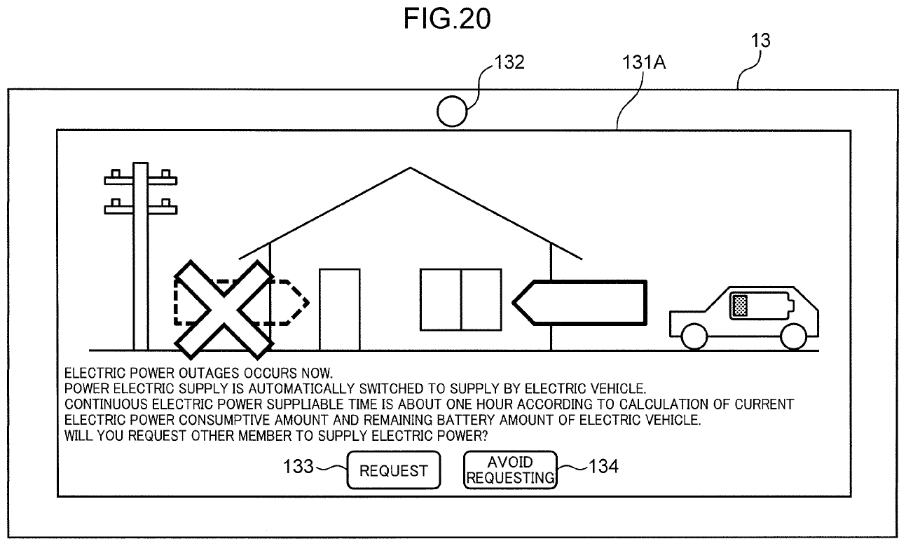

FIG. 20 shows an example of the request confirmation screen image in the modification of the first embodiment.

The display part 13 displays a request confirmation screen image 131A thereon. As shown in FIG. 20, the request confirmation screen image 131A is aimed at notifying the resident of the occurrence of the power outage in the house 1. The request confirmation screen image 131 is further aimed at notifying the resident of the electric power suppliable time indicating the time available for the first electric vehicle 3A in the state of supplying the electric power to continue the supplying of the electric power to the house 1. The request confirmation screen image 131A includes a first button 133 and a second button 134 for receiving an input as to whether to request other member to supply electric power to the house 1. The other member represents a resident of other house preregistered in the user DB 241 of the server 2. The first button 133 is touched to make the request for the electric power supply to the house 1. The second button 134 is touched to avoid the request for the electric power supply to the house 1.

Referring back to FIG. 18, next, in step S65, the request confirmation display control section 172A determines whether the request for the electric power supply to the house 1 having the power outage is made.

Steps S65 to S70 are the same as steps S3 to S8 in FIG. 5, and thus the descriptions therefor are omitted. Here, in the modification of the first embodiment, the second electric vehicle 3B is retrieved as a candidate electric vehicle for the electric power supply to the house 1 having the power outage.

Next, in step S71, the electric power supply control section 176 determines whether the second electric vehicle 3B is connected to the charging and discharging device 104. The vehicle connection detecting section 175 detects connection of the second electric vehicle 3B to the charging and discharging device 104. Here, when it is determined that the second electric vehicle 3B is not connected to the charging and discharging device 104 (NO in step S71), the process returns to step S69.

Contrarily, when it is determined that the second electric vehicle 3B is connected to the charging and discharging device 104 (YES in step S71), the electric power supply control section 176 outputs, to the second electric vehicle 3B, an electric power supply instruction to start the electric power supply by the second electric vehicle 3B in step S72. When the second electric vehicle 3B receives an input of the electric power supply instruction, the second electric vehicle 3B supplies the electric power to the loader 105 via the power distribution board 103.

Although the second electric vehicle 3B is connected to the charging and discharging device 104 in the modification of the first embodiment, this disclosure is not particularly limited thereto. The second electric vehicle 3B may be connected to the first electric vehicle 3A. In this case, the electric power supply control section 176 determines whether the second electric vehicle 3B is connected to the first electric vehicle 3A. The vehicle connection detecting section 175 detects connection of the second electric vehicle 3B to the first electric vehicle 3A. Here, when it is determined that the second electric vehicle 313 is not connected to the first electric vehicle 3A, the process returns to step S69. Contrarily, when it is determined that the second electric vehicle 3B is connected to the first electric vehicle 3A, the electric power supply control section 176 outputs, to the second electric vehicle 3B, an electric power supply instruction to start the electric power supply by the second electric vehicle 3B. When the second electric vehicle 3B receives an input of the electric power supply instruction, the second electric vehicle 3B supplies the electric power to the first electric vehicle 3A. The first electric vehicle 3A stores the electric power supplied from the second electric vehicle 3B, and supplies the stored electric power to the loader 105 via the power distribution board 103.

Subsequently, in step S73, the power outage cease information acquisition section 174 determines whether power outage cease information indicating that the power outage of the house 1 has ceased is acquired from the power distribution board 103. Here, when it is determined that the power outage cease information is not acquired (NO in step S73), the electric power supply control section 176 determines, in step S74, whether the second electric vehicle 3B is disconnected from the charging and discharging device 104. The vehicle connection detecting section 175 detects disconnection of the second electric vehicle 3B from the charging and discharging device 104. Here, when it is determined that the second electric vehicle 3B is not disconnected from the charging and discharging device 104 (NO in step S74), the process returns to step S73.

Contrarily, when it is determined that the second electric vehicle 3B is disconnected from the charging and discharging device 104 (YES in step S74), the supply request finish information transmitting section 124 transmits supply request finish information to the server 2 in step S75. At this time, the house 1 still has the power outage under non-acquisition of the power outage cease information. Therefore, the process having undergone step S75 returns to step S62. Next, in step S62, the electric power supply control section 176 outputs, to the first electric vehicle 3A, an electric power supply instruction to start the electric power supply by the first electric vehicle 3A. In this way, the electric power supply by the first electric vehicle 3A is resumed to execute step S62 and subsequent steps.

Contrarily, when it is determined that the power outage cease information is acquired (YES in step S73), the power outage cease information transmitting section 123 transmits, to the server 2, power outage cease information indicating that the power outage of the house 1 has ceased in step S76.

Next, in step S77, the electric power supply control section 176 outputs, to the second electric vehicle 3B, an electric power supply finish instruction to finish the electric power supply by the second electric vehicle 3B. When the second electric vehicle 3B receives an input of the electric power supply finish instruction, the second electric vehicle 3B stops the electric power supply. Thereafter, the second electric vehicle 3B is disconnected from the charging and discharging device 104.

Then, in step S78, the supply request finish information transmitting section 124 transmits supply request finish information to the server 2.

As described heretofore, in the case where the first electric vehicle 3A is in the state of supplying the electric power to the house 1 having the power outage, the second electric vehicle 3B that enables an electric power supply reaches the house before the battery remaining amount of the first electric vehicle 3A in the state of supplying the electric power runs out, and thus can take over the electric power supply to the house 1 having the power outage without suspension.

Although the storage battery 31 of the first electric vehicle 3A is connected to the charging and discharging device 104 in the modification of the embodiment, this disclosure is not particularly limited thereto. A stationary domestic storage battery may be connected to the charging and discharging device 104.

### Second Embodiment

In the first embodiment, the server retrieves a candidate electric vehicle and transmits cooperation request information to the retrieved candidate electric vehicle. By contrast, in a second embodiment, a server retrieves one or more candidate electric vehicles, transmits, to a house 1, vehicle presentation information for presenting information about the retrieved one or more candidate electric vehicles before a resident of the house 1, and transmits cooperation request information to a candidate electric vehicle selected from the one or more candidate electric vehicles by the resident of the house 1.

An information processing system in the second embodiment has a configuration including an electric power supply controller 101B in place of the electric power supply controller 101 of the information processing system shown in FIG. 1, and a server 2B in place of the server 2 of the system. Hence, explanation for the configuration of the information processing system in the second embodiment is omitted.

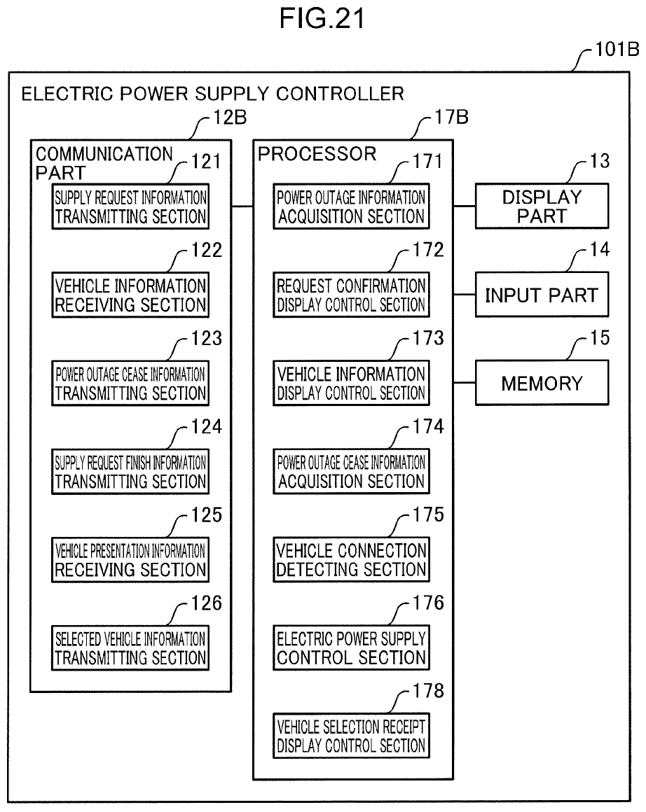

FIG. 21 shows a configuration of the electric power supply controller in the second embodiment of the disclosure.

The electric power supply controller 101B shown in FIG. 21 includes a communication part 12B, a display part 13, an input part 14, a memory 15, and a processor 17B. In the second embodiment, elements which are the same as those in the first embodiment are given the same reference signs and numerals, and thus explanation therefor will be omitted.

The communication part 12B includes a supply request information transmitting section 121, a vehicle information receiving section 122, a power outage cease information transmitting section 123, a supply request finish information transmitting section 124, a vehicle presentation information receiving section 125, and a selected vehicle information transmitting section 126.

The processor 17B includes a power outage information acquisition section 171, a request confirmation display control section 172, a vehicle information display control section 173, a power outage cease information acquisition section 174, a vehicle connection detecting section 175, an electric power supply control section 176, and a vehicle selection receipt display control section 178.

The vehicle presentation information receiving section 125 receives vehicle presentation information for presenting information about the one or more candidate electric vehicles retrieved by the server 2B before the resident of the house 1.

The vehicle selection receipt display control section 178 causes the display part 13 to display a vehicle selection receipt screen image for presenting the information about the one or more candidate electric vehicles retrieved by the server 2B before the resident of the house 1 and receiving selection of a desired candidate electric vehicle from the one or more candidate electric vehicles by the resident.

The selected vehicle information transmitting section 126 transmits, to the server 2B, selected vehicle information about the candidate electric vehicle selected from the one or more candidate electric vehicles by the resident.

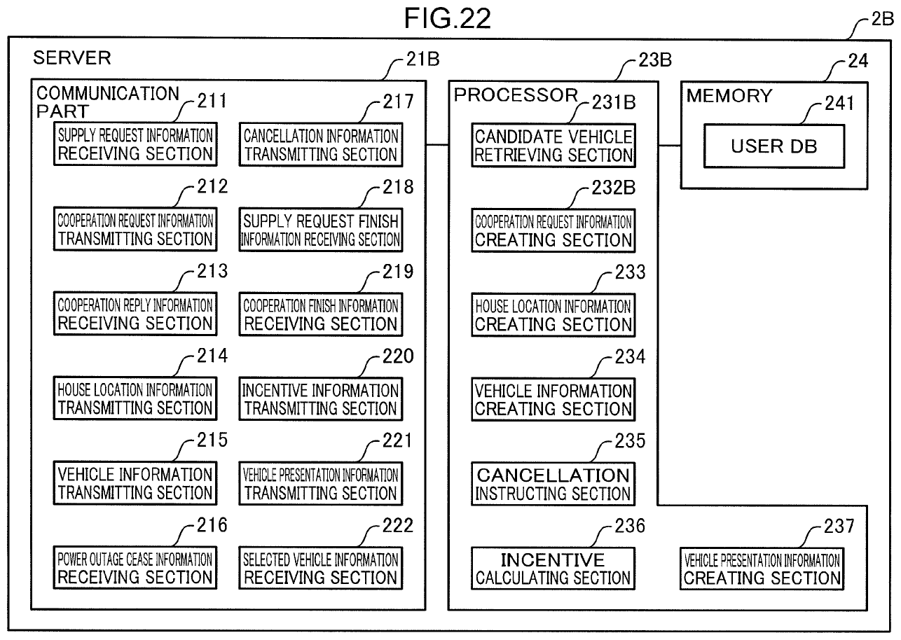

FIG. 22 shows a configuration of the server in the second embodiment of the disclosure.

The server 2B shown in FIG. 22 includes a communication part 21B, a memory 24, and a processor 23B.

The communication part 21B includes a supply request information receiving section 211, a cooperation request information transmitting section 212, a cooperation reply information receiving section 213, a house location information transmitting section 214, a vehicle information transmitting section 215, a power outage cease information receiving section 216, a cancellation information transmitting section 217, a supply request finish information receiving section 218, a cooperation finish information receiving section 219, an incentive information transmitting section 220, a vehicle presentation information transmitting section 221, and a selected vehicle information receiving section 222.

The processor 23B includes a candidate vehicle retrieving section 231B, a cooperation request information creating section 232B, a house location information creating section 233, a vehicle information creating section 234, a cancellation instructing section 235, an incentive calculating section 236, and a vehicle presentation information creating section 237.

The candidate vehicle retrieving section 231B retrieves one or more candidate electric vehicles.

The candidate vehicle retrieving section 231B retrieves the one or more candidate electric vehicles among electric vehicles each having a battery remaining amount which is larger than a travel power consumptive amount required for each electric vehicle traveling from a current position thereof to a chargeable place via the house 1. Alternatively, the candidate vehicle retrieving section 231 may retrieve one or more candidate electric vehicles among electric vehicles in order of largest residual amount in subtraction of a travel power consumptive amount from a battery remaining amount thereof.

The candidate vehicle retrieving section 231 may retrieve one or more candidate electric vehicles, among the electric vehicles, in order of shortest travel time from a current position of each electric vehicle to the house 1 or in order of shortest travel distance from the current position of each electric vehicle to the house 1. The candidate vehicle retrieving section 231 may retrieve one or more candidate electric vehicles in order of shortest travel time from a current position of each electric vehicle to the house 1 or in order of shortest travel distance from the current position of each vehicle to the house 1 among electric vehicles each having a battery remaining amount which is larger than a travel power consumptive amount required for each electric vehicle to travel from a current position thereof to a chargeable place via the house 1.

The candidate vehicle retrieving section 231 may retrieve one or more candidate electric vehicles in order of shortest travel time from a current position of each electric vehicle to the house 1 or in order of shortest travel distance from the current position of each electric vehicle to the house 1 among electric vehicles each having a larger residual amount in subtraction of a travel power consumptive amount from a battery remaining amount thereof than a predetermined amount.

The candidate vehicle retrieving section 231 may retrieve one or more candidate electric vehicles in order of largest residual amount in subtraction of a travel power consumptive amount from a battery remaining amount thereof among electric vehicles each having a shorter travel time from a current position thereof to the house 1 than a predetermined time. The candidate vehicle retrieving section 231 may retrieve one or more candidate electric vehicles in order of largest residual amount in subtraction of a travel power consumptive amount from a battery remaining amount thereof among electric vehicles each having a shorter travel distance from a current position thereof to the house 1 than a predetermined distance.

The vehicle presentation information creating section 237 creates vehicle presentation information for presenting information about the one or more candidate electric vehicles retrieved by the candidate vehicle retrieving section 231B before the resident of the house 1.

The vehicle presentation information transmitting section 221 transmits the vehicle presentation information to the house 1. The vehicle presentation information transmitting section 221 transmits the vehicle presentation information to the electric power supply controller 101B of the house 1.

The selected vehicle information receiving section 222 receives, from the house 1, selected vehicle information about a candidate electric vehicle selected from the one or more candidate electric vehicles by the resident of the house 1. The selected vehicle information receiving section 222 receives the selected vehicle information from the electric power supply controller 101B of the house 1.

The cooperation request information creating section 232B transmits cooperation request information (second request information) to a terminal associated with the candidate electric vehicle indicated by the selected vehicle information received by the selected vehicle information receiving section 222.

Next, an operation by the electric power supply controller 101B in the second embodiment of the disclosure will be described.

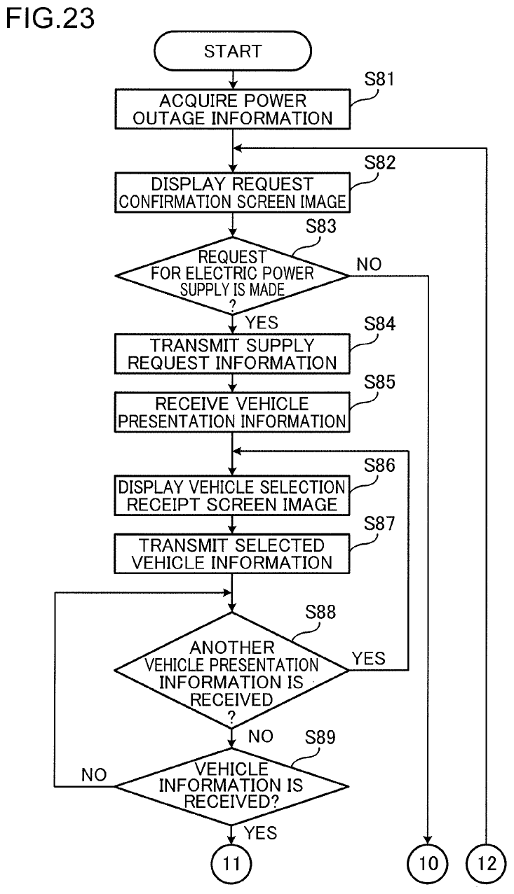

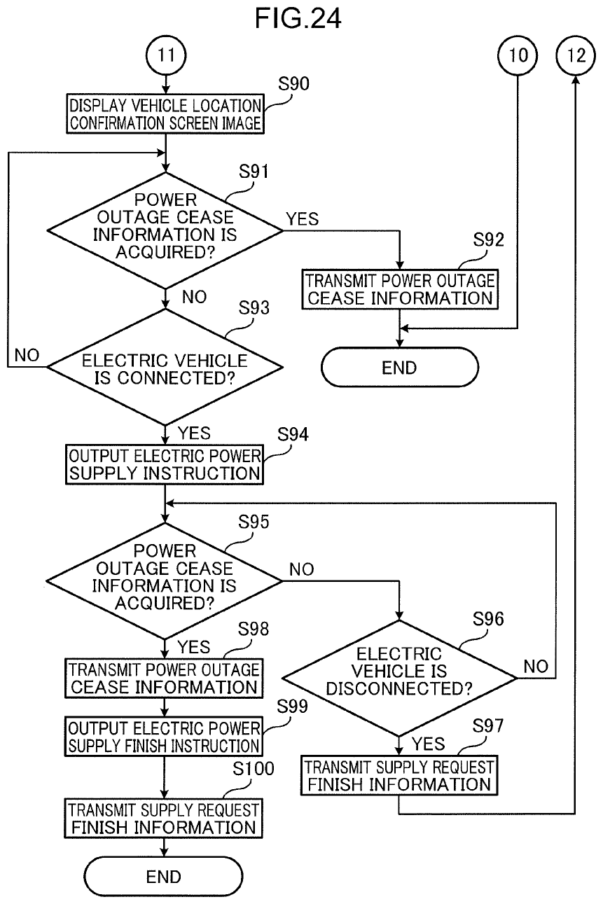

FIG. 23 is a first flowchart explaining the operation by the electric power supply controller in the second embodiment of the disclosure. FIG. 24 is a second flowchart explaining the operation by the electric power supply controller in the second embodiment of the disclosure.

Steps S81 to S84 are the same as steps S1 to S4 in FIG. 5, and thus the descriptions therefor are omitted.

Subsequently, in step S85, the vehicle presentation information receiving section 125 receives vehicle presentation information for presenting information about one or more candidate electric vehicles retrieved by the server 2B before the resident of the house 1.

Then, in step S86, the vehicle selection receipt display control section 178 causes the display part 13 to display a vehicle selection receipt screen image for presenting the information about the one or more candidate electric vehicles retrieved by the server 2B before the resident of the house 1 and receiving selection of a desired electric vehicle from the one or more candidate electric vehicles by the resident.

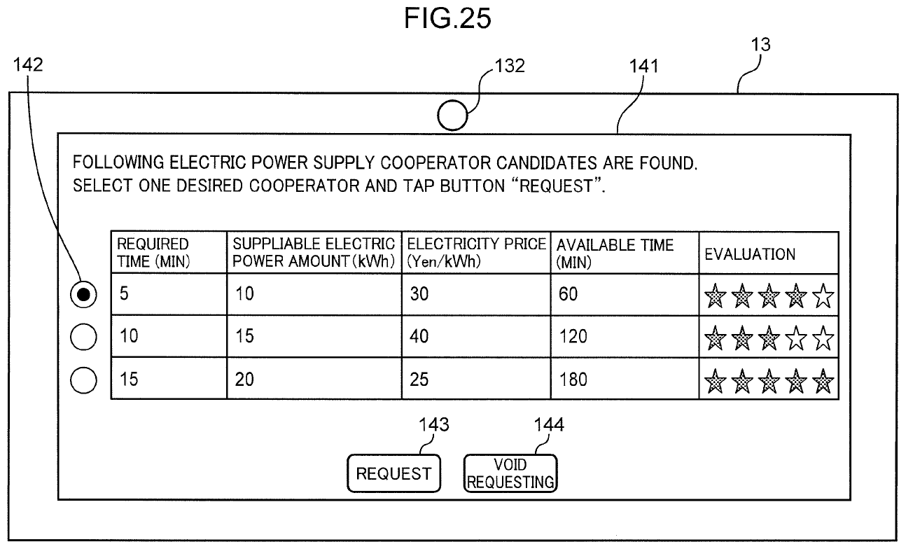

FIG. 25 shows an example of the vehicle selection receipt screen image in the second embodiment.

The display part 13 displays a vehicle selection receipt screen image 141 thereon. As shown in FIG. 25, the vehicle selection receipt screen image 141 is aimed at giving notification about a found electric power supply cooperator candidate, and presenting information about one or more candidate electric vehicles. FIG. 25 shows presentation of information about three candidate electric vehicles. The information about the candidate electric vehicles includes a time required for each candidate electric vehicle to reach the house 1, a suppliable electric power amount of the candidate electric vehicle, an electricity price to occur in an electric power supply by the candidate electric vehicle, an available time for the candidate electric vehicle, and evaluation to a user of the candidate electric vehicle.

The suppliable electric power amount represents a residual amount in subtraction of a travel power consumptive amount required for the candidate electric vehicle to travel from the current position thereof to a chargeable place via the house 1 from a battery remaining amount of the candidate electric vehicle. The electricity price is preliminarily set by the user of the candidate electric vehicle, and stored in a user DB 241 of the server 2B in advance. The available time is preset by the user of the candidate electric vehicle, and stored in the user DB 241 of the server 2B in advance. The evaluation is rated, for example, on a scale of one to five. The evaluation here represents an average value of evaluation degrees given by others to the user of the candidate electric vehicle, and is stored in the user DB 241 of the server 2B. The evaluation may include evaluation to the user of the candidate electric vehicle in the service and another evaluation to the user of the candidate electric vehicle in another service, such as, a personal trading service.

Although the information about the candidate electric vehicle includes five items of the required time, the suppliable electric power amount, the electricity price, the available time, and the evaluation, this disclosure is not particularly limited thereto. The number of items for the presentation may be fewer than five, or may be more than five. Moreover, the resident of the house 1 may preset a specific way of displaying the items.

The resident of the house 1 may give a priority to each of the items of the required time, the suppliable electric power amount, the electricity price, the available time, and the evaluation. For instance, when the highest priority is given to the required time, a predetermined number of candidate electric vehicles may be displayed in order of shortest required time. Alternatively, for example, when the highest priority is given to the suppliable electric power amount, a predetermined number of candidate electric vehicles may be displayed in order of largest suppliable electric power amount.

The vehicle selection receipt screen image 141 includes a radio button 142 for selecting a desired candidate electric vehicle from the presented one or more candidate electric vehicles, a first button 143 for requesting a user of the selected electric vehicle to supply electric power to the house 1, and a second button 144 for avoiding the request for the electric power supply. The resident of the house 1 touches the radio button 142 corresponding to the desired electric vehicle among the presented one or more candidate electric vehicles and touches the first button 143 to make the request for the electric power supply to the house 1. By contrast, the resident of the house 1 touches the second button 144 to avoid the request for the electric power supply to the house 1. When the second button 144 for avoiding the request for the electric power supply is selected on the vehicle selection receipt screen image 141, the process may be finished.

Referring back to FIG. 23, in step S87, the selected vehicle information transmitting section 126 transmits, to the server 2B, selected vehicle information about the candidate electric vehicle selected from the one or more candidate electric vehicles by the resident.

Subsequently, in step S88, the vehicle selection receipt display control section 178 determines whether the vehicle presentation information receiving section 125 receives another vehicle presentation information. This is because the user of the selected candidate electric vehicle does not necessarily accept the request for the electric power supply. When the user of the selected candidate electric vehicle accepts the request for the electric power supply, the server 2B transmits vehicle information about the candidate electric vehicle showing the acceptance. Contrarily, when the user of the selected candidate electric vehicle does not accept the request for the electric power supply, the server 2B transmits another vehicle presentation information to the resident of the house 1 for allowing the resident to select another candidate electric vehicle.

Here, when it is determined that another vehicle presentation information is received (YES in step S88), the process returns to step S86. Then, the vehicle selection receipt screen image 141 is redisplayed to allow the resident of the house 1 to select another candidate electric vehicle.

Contrarily, when it is determined that another vehicle presentation information is not received (NO in step S88), the vehicle information display control section 173 determines, in step S89, whether the vehicle information receiving section 122 receives the vehicle information. Here, when it is determined that the vehicle information is not received (NO in step S89), the process returns to step S88.

Contrarily, when it is determined that the vehicle information is received (YES in step S89), in step S90, the vehicle information display control section 173 causes the display part 13 to display, based on the vehicle information received by the vehicle information receiving section 122, a vehicle position confirmation screen image showing a current position of an electric vehicle 3 traveling to the house 1.

Steps S90 to S100 are the same as steps S6 to S16 in FIG. 5 and FIG. 6, and thus the descriptions therefor are omitted.

Next, an operation by the server 2B in the second embodiment of the disclosure will be described.

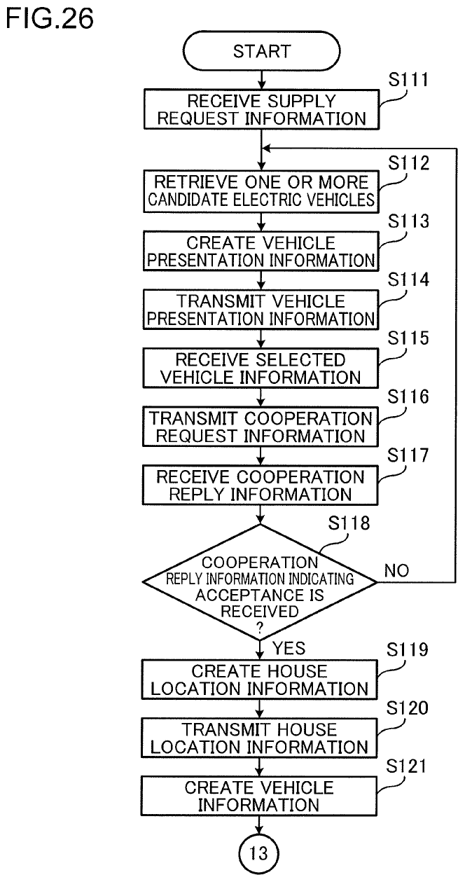

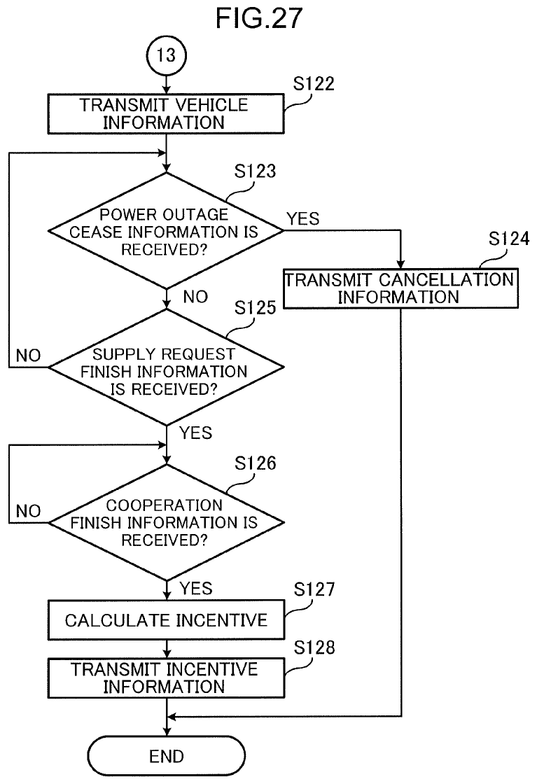

FIG. 26 is a first flowchart explaining the operation by the server in the second embodiment of the disclosure. FIG. 27 is a second flowchart explaining the operation by the server in the second embodiment of the disclosure.

First, in step S111, the supply request information receiving section 211 receives supply request information transmitted by the electric power supply controller 101B.

Subsequently, in step S112, the candidate vehicle retrieving section 231B retrieves, with reference to the user DB 241, one or more candidate electric vehicles each of which enables an electric power supply to the house 1 among electric vehicles associated with other houses different from the house 1 having power outage. At this time, the candidate vehicle retrieving section 231B preferably retrieves a plurality of candidate electric vehicles to allow the resident of the house 1 to select a desired candidate electric vehicle from a greater number of electric vehicles.

For instance, the candidate vehicle retrieving section 231B retrieves a predetermined number of candidate electric vehicles in order of shortest travel time from a current position of each electric vehicle to the house 1 among electric vehicles each having a larger residual amount in subtraction of a travel power consumptive amount from a battery remaining amount thereof than a predetermined amount. The predetermined number includes, for example, three. For retrieval of a plurality of candidate electric vehicles by the candidate vehicle retrieving section 231B, various retrieval ways as described in the examples in the first and second embodiments are applicable without limitation to this way.

The resident of the house 1 may give a priority to each of the items of the required time, the suppliable electric power amount, the electricity price, the available time, and the evaluation. For instance, when the highest priority is given to the required time, the candidate vehicle retrieving section 231B may retrieve a predetermined number of candidate electric vehicles in order of shortest required time (travel time). Alternatively, for example, when the highest priority is given to the suppliable electric power amount, the candidate vehicle retrieving section 231B may retrieve a predetermined number of candidate electric vehicles in order of largest suppliable electric power amount.

Next, in step S113, the vehicle presentation information creating section 237 creates vehicle presentation information for presenting information about the one or more candidate electric vehicles retrieved by the candidate vehicle retrieving section 231B before the resident of the house 1.

Subsequently, in step S114, the vehicle presentation information transmitting section 221 transmits the vehicle presentation information created by the vehicle presentation information creating section 237 to the electric power supply controller 101B.

Then, in step S115, the selected vehicle information receiving section 222 receives selected vehicle information transmitted by the electric power supply controller 101B.

Subsequently, in step S116, the cooperation request information creating section 232B transmits cooperation request information to a terminal 4 associated with the candidate electric vehicle indicated by the selected vehicle information received by the selected vehicle information receiving section 222.

Further, in step S117, the cooperation reply information receiving section 213 receives, from the terminal 4, cooperation reply information indicating acceptance or unacceptance of the electric power supply to the house 1.

Moreover, in step S118, the house location information creating section 233 determines whether cooperation reply information indicating acceptance is received. Here, when it is determined that cooperation reply information indicating unacceptance is received (NO in step S118), the process returns to step S112, and another one or more candidate electric vehicles are retrieved. At this time, the candidate vehicle retrieving section 231B excludes the candidate electric vehicle showing the unacceptance of the request for the electric power supply from electric vehicles associated with houses different from the house 1 having the power outage, and retrieves another one or more candidate electric vehicles each of which enables the electric power supply to the house 1.

Contrarily, when it is determined that the cooperation reply information indicating the acceptance is received (YES in step S118), the house location information creating section 233 creates house location information about a location of the house 1 having the power outage in step S119.

Steps S119 to S128 are the same as steps S27 to S36 in FIG. 9 and FIG. 10, and thus the descriptions therefor are omitted.

As described heretofore, the cooperation request information is transmitted to the terminal associated with the candidate electric vehicle selected from the retrieved one or more candidate electric vehicles by the resident of the house 1. This permits the candidate electric vehicle desired by the resident of the house 1 to travel to the house 1.

In each embodiment, each constituent element may be realized with dedicated hardware or by executing a software program suitable for the constituent element. Each constituent element may be realized by a program execution unit, such as a CPU or a processor, reading out and executing a software program recorded on a recording medium, such as a hard disk or a semiconductor memory. Other independent computer system may implement a program by recording the program in a recording medium to be transferred, or transferring the program via a network.

A part or all of functions of the device according to the embodiment of the disclosure are typically realized as a large scale integration (LSI), which is an integrated circuit. These functions may be formed as separate chips, or some or all of the functions may be included in one chip. The circuit integration is not limited to the LSI, and may be realized with a dedicated circuit or a general-purpose processor. A field programmable gate array (FPGA) that is programmable after manufacturing of an LSI or a reconfigurable processor in which connections and settings of circuit cells within the LSI are reconfigurable may be used.

A part or all of functions of the device according to the embodiment of the present disclosure may be implemented by a processor, such as a CPU executing a program.

Numerical values used above are merely illustrative to be used to specifically describe the present disclosure, and thus the present disclosure is not limited to the illustrative numerical values.

Order in which steps shown in the flowcharts are executed is merely illustrative to be used to specifically describe the present disclosure, and thus steps may be executed in order other than the above order as long as similar effects are obtained. Some of the steps may be executed simultaneously (in parallel) with other steps.

### INDUSTRIAL APPLICABILITY

The technology according to this disclosure achieves an electric power supply to a house even in power outage, and therefore is useful for managing an electric power supply to the house by an electric vehicle.

1. An electric power supply management method, by a computer, comprising:
receiving, from a certain house having power outage among a plurality of houses, first request information about a request for an electric power supply to the certain house;
retrieving, with reference to a database associating the houses with a plurality of electric vehicles configured to supply electric power respectively to the houses, a candidate electric vehicle that enables the electric power supply to the certain house among the electric vehicles associated with other houses different from the certain house;
transmitting, to a terminal associated with the retrieved candidate electric vehicle, second request information about a request for the electric power supply from the candidate electric vehicle to the certain house; and
transmitting, when receiving from the terminal reply information indicating acceptance of the electric power supply to the certain house, location information about a location of the certain house to the terminal.

2. The electric power supply management method according to claim 1, further comprising receiving, in a case where a specific electric vehicle is in a state of supplying electric power to the certain house, from the certain house an electric power suppliable time indicating a time available for the specific electric vehicle in the state of supplying electric power to continue the supplying of electric power to the house, wherein,
in the retrieval of the candidate electric vehicle, the candidate electric vehicle is among electric vehicles each having a possibility of reaching the certain house within the electric power suppliable time.

3. The electric power supply management method according to claim 1, wherein,
in the retrieval of the candidate electric vehicle, the candidate electric vehicle is among electric vehicles each having a battery remaining amount which is larger than a power consumptive amount required for the electric vehicle traveling from a current position thereof to a chargeable place via the certain house.

4. The electric power supply management method according to claim 3, wherein,
in the retrieval of the candidate electric vehicle, the candidate electric vehicle provides a largest residual amount in subtraction of the power consumptive amount from the battery remaining amount thereof.

5. The electric power supply management method according to claim 1, wherein,
in the retrieval of the candidate electric vehicle, the candidate electric vehicle has a shortest travel time from a current position thereof to the certain house among the electric vehicles or has a shortest travel distance from a current position thereof to the certain house among the electric vehicles.

6. The electric power supply management method according to claim 1, further comprising:
receiving, from the certain house, power outage cease information indicating that the power outage has ceased; and
transmitting, to the terminal, cancellation information about cancellation of the request for the electric power supply to the certain house, upon receiving the power outage cease information after transmitting the second request information.

7. The electric power supply management method according to claim 1, further comprising:
calculating an incentive to be given to a user of the candidate electric vehicle for the electric power supply to the certain house by the candidate electric vehicle; and
transmitting information about the calculated incentive to the terminal.

8. The electric power supply management method according to claim 7, wherein,
in the calculation of the incentive, the incentive is calculated to increase in accordance with an increase in the amount of the electric power supply from the candidate electric vehicle to the certain house, in a traveling time of the candidate electric vehicle to the certain house, or in a power supplying time of the candidate electric vehicle to the certain house.

9. The electric power supply management method according to claim 1, further comprising transmitting the current position of the candidate electric vehicle when receiving, from the terminal, the reply information indicating the acceptance of the electric power supply to the certain house.

10. The electric power supply management method according to claim 1, wherein,
in the retrieval of the candidate electric vehicle, one or more candidate electric vehicles are retrieved, the method further comprising:
transmitting, to the certain house, vehicle presentation information for presenting information about the retrieved one or more candidate electric vehicles before a resident of the certain house;
receiving, from the certain house, selected vehicle information about a candidate electric vehicle selected from the retrieved one or more candidate electric vehicles by the resident; and
transmitting, in the transmission of the second request information, the second request information to the terminal associated with the candidate electric vehicle indicated by the received selected vehicle information.

11. The electric power supply management method according to claim 1, further comprising,
when receiving reply information indicating unacceptance of the electric power supply to the certain house from the terminal, retrieving, with reference to the database, another candidate electric vehicle that enables the electric power supply to the certain house among electric vehicles associated with the houses except for the electric vehicle showing the unacceptance.

12. An electric power supply management device comprising:
a first request information receiving section that receives, from a certain house having power outage among a plurality of houses, first request information about a request for an electric power supply to the certain house;
a retrieving section that retrieves, with reference to a database associating the houses with a plurality of electric vehicles configured to supply electric power respectively to the houses, a candidate electric vehicle that enables the electric power supply to the certain house among electric vehicles associated with other houses different from the certain house;
a second request information transmitting section that transmits, to a terminal associated with the retrieved candidate electric vehicle, second request information about a request for the electric power supply from the candidate electric vehicle to the certain house; and
a location information transmitting section that transmits, when receiving from the terminal reply information indicating acceptance of the electric power supply to the certain house, location information about a location of the certain house to the terminal.

13. A non-transitory computer readable recording medium storing an electric power supply management program of causing a computer to serve as:
receiving, from a certain house having power outage among a plurality of houses, first request information about a request for an electric power supply to the certain house;
retrieving, with reference to a database associating the houses with a plurality of electric vehicles configured to supply electric power respectively to the houses, a candidate electric vehicle that enables the electric power supply to the certain house among the electric vehicles associated with other houses different from the certain house;
transmitting, to a terminal associated with the retrieved candidate electric vehicle, second request information about a request for the electric power supply from the candidate electric vehicle to the certain house; and
transmitting, when receiving from the terminal reply information indicating acceptance of the electric power supply to the certain house, location information about a location of the certain house to the terminal.
